(19) United States
(12) Patent Application Publication
(10) Pub. No.: US 2014/0299529 A1
(43) Pub. Date: Oct. 9, 2014

(54) Systems, Apparatus, and Methods for Separating Salts from Water

(71) Applicant: Advanced Water Recovery, LLC, Rapid City, SD (US)

(72) Inventors: Rakesh Govind, Cincinnati, OH (US); Robert Foster, Calgary (CA)

(21) Appl. No.: 14/310,388

(22) Filed: Jun. 20, 2014

Related U.S. Application Data
(63) Continuation-in-part of application No. 14/099,306, filed on Dec. 6, 2013.
(60) Provisional application No. 61/878,861, filed on Sep. 17, 2013.
(60) Provisional application No. 61/757,891, filed on Jan. 29, 2013.
(60) Provisional application No. 61/735,211, filed on Dec. 10, 2012.
(60) Provisional application No. 61/734,491, filed on Dec. 7, 2012.

(51) Int. Cl. C02F 1/469; C02F 1/26

(52) U.S. Cl. CPC C02F 1/4693; C02F 1/265
USPC 210/195.2; 210/243; 204/665; 205/746; 205/748

(57) ABSTRACT

A system, method, and apparatus for desalinating water, such as seawater. The system, method, and/or apparatus includes an electrodialysis cell that can separate monovalent ionic species from multivalent ionic species, so they may be separately treated. Each separate treatment may include precipitation of salt via the use of an organic solvent, followed by processing of precipitated salts and membrane treatment of water to remove solvent and remaining salts.

### CROSS-REFERENCE TO RELATED APPLICATIONS

This application is a continuation-in-part of U.S. patent application Ser. No. 14/099,306, entitled “Systems, Apparatus, and Methods for Separating Salts from Water,” filed on Dec. 6, 2013, which claims the benefit of the filing date of U.S. Patent Application No. 61/878,861, entitled, “Apparatus and Method for Separating Salts from Water, filed on Sep. 17, 2013; U.S. Patent Application No. 61/757,891, entitled, “Solvent Precipitation and Concentration of Salts,” filed on Jan. 29, 2013; U.S. Patent Application No. 61/735,211, entitled “Process for Converting Brackish/Produced Water to Useful Products and Reusable Water,” filed on Dec. 10, 2012, and U.S. Patent Application No. 61/734,491, entitled “Process for Converting Brackish/Produced Water to Useful Products and Reusable Water”, filed on Dec. 7, 2012. The disclosures of all of U.S. patent application Ser. Nos. 14/099,306, 61/878,861, 61/757,891, 61/735,211, and 61/734,491 are incorporated by reference herein in their entireties.

### FIELD OF THE INVENTION

Aspects of the present invention generally relate to methods of, apparatus for, and systems for separating materials from a liquid, and, more specifically, in certain embodiments relate to methods of, apparatus for, and systems for separating salts from water (such as seawater, or discharge brines from water treatment processes).

### BACKGROUND OF THE INVENTION

This section is intended to introduce the reader to various aspects of art that may be related to various aspects of the present invention, which are described and/or claimed below. This discussion is believed to be helpful in providing the reader with background information to facilitate a better understanding of various aspects of the present invention. Accordingly, it should be understood that these statements are to be read in this light, and not as admissions of prior art.

As population grows, the strain on the world's freshwater supplies will increase. By 2025, it is estimated that about 2.7 billion people, nearly one-third of the projected population, will live in regions facing severe water scarcity according to the International Water Management Institute. Many prosperous and fast growing regions—e.g., the American Southwest, Florida, and Asia—have inadequate freshwater supplies. Nevertheless, other factors such as a pleasant climate, mineral resources, job growth, and rising incomes drive growth in these regions. The needs of municipalities, industry, and citizens must be met, even as the difficulty and cost of developing new water resources increases. Desalination has become a popular option in regions where there is abundant water that is unsuitable for use due to high salinity, and there are opportunities for desalination plants that utilize thermal, electrical, or mechanical energy to recover potable water from salty solutions. The choice of desalination process type depends on many factors including salinity levels in the raw water, quantities of water needed, and the form and cost of available energy.

One example of a desalination process is one that uses reverse osmosis membranes. Modern reverse osmosis (RO) membranes achieve such high levels of salt rejection that they are capable of producing potable water (less than 500 parts per million [ppm] salinity) from seawater (nominally 35,000 ppm salinity). Furthermore, some modern RO systems are capable of achieving up to 50 percent (%) recovery of freshwater from seawater. Seawater RO plants operating at 50% recovery thus produce a brine waste stream having about 70,000 ppm salinity. Disposal of such brines presents significant costs and challenges for the desalination industry, which increase the time required for permits and construction of new plants and result in higher cost of water. There are three basic ways to deal with brines from seawater desalination—discharge to the sea, deep well injection, and zero liquid discharge (ZLD) systems. However, each of these methods presents substantial drawbacks.

For example, regarding discharge to the sea: Brine disposal to surface waters in the United States requires National Pollutant Discharge Elimination System permits, which are difficult to obtain in many areas. The discharge of brines back into the sea can affect the organisms in the discharge area. The greatest environmental concern associated with brine discharge to surface water relates to the potential harm that disposal of the brine may pose to bottom-dwelling organisms located in the discharge area. Following the guideline that a 1,000-part-per-million (ppm) change in the salinity can be tolerated by most organisms, the volume of 70,000-ppm brine from a seawater reverse osmosis (SWRO) plant would require dilution with 35 volumes of seawater. In some cases, that dilution can be achieved by combining the brine with another outflow such as cooling water from a power plant; otherwise, an underwater structure is needed to disperse the brine. Such underwater structures are disruptive to the sea bottom, require inspection and maintenance, and are subject to damage by fishing nets, anchors, or natural movements at the sea bottom.

Further, the cost of brine disposal to the sea will vary widely depending upon site-specific circumstances. The cost of pipelines into the deep ocean, where the effects are more likely to be negligible, increase exponentially with depth. The capital cost of the Tampa Bay Number 2 desalination plant per cubic meter of product is estimated at $4,587 for long-distance brine disposal versus $3,057 for near shore disposal.

Further, the disposal of brine imposes significant costs and permitting requirements including: (1) direct disposal costs, such as injection wells, pipelines, water quality sampling, and in-stream biodiversity studies, which can represent between 10 and 50% of the total cost of freshwater production; and (2) time and expense required to obtain discharge permits, which can be substantial. For the 25-million-gallon-per-day SWRO plant in Tampa, Fla., it took 12 months to obtain the National Pollutant Discharge Elimination System (NPDES) permit for brine disposal to the sea. Approvals from eight different state agencies were required, and the developer had to agree to conduct extensive long-term monitoring of receiving waters. Siting on Tampa Bay was feasible only because the concentrate (brine) will be diluted by a factor of 70 before it is discharged into Tampa Bay. The plan calls for the concentrate (brine) to be mixed with cooling water from the neighboring 1,825-megawatt (MW) Big Bend power station.

As described above, another method for disposal of brine is deep well disposal. Deep well disposal is often used for hazardous wastes, and it has been used for desalination brines in Florida. Published estimates of capital costs are approximately $1 per gallon per day (gpd) of desalination capacity. The applicability of deep well injection for large desalination plants is questionable because of the sheer volume of the brine and the possibility of contamination of ground water.

In the last half century, global demand for freshwater has doubled approximately every 15 years. This growth has reached a point where today existing freshwater resources are under great stress, and it has become both more difficult and more expensive to develop new freshwater resources. One especially relevant issue is that a large proportion of the world's population (approximately 70 percent) dwells in coastal zones. Many of these coastal regions, including those in the Southeastern and Southwestern United States, rely on underground aquifers for a substantial portion of their freshwater supply. Coastal aquifers are highly sensitive to anthropogenic disturbances.

In particular, if an aquifer is overdrawn, it can become contaminated by an influx of seawater and, therefore, requires desalination. So the combined effects of increasing freshwater demand and seawater intrusion into coastal aquifers are stimulating the demand for desalination. Coastal locations on sheltered bays or near estuaries, protected wetlands, and other sensitive ecosystems are more likely to have trouble disposing of concentrated solutions that are produced when water is removed from a feed solution. Concentrate disposal problems rule out many otherwise suitable locations for industrial and municipal facilities for desalination of seawater and brackish water reverse osmosis. For example, because the concentrate is in liquid form, it is more difficult to dispose of because liquid is more difficult to control (e.g., it can seep into soil, etc.). These concentrate-disposal-constrained sites represent an important potential area for the application of zero liquid discharge (ZLD). A ZLD system evaporates brine leaving a salt residue for disposal or reuse.

However, the high cost of commercially available ZLD technology (e.g., brine concentrators and crystallizers) and the limitations of experimental technologies such as solar ponds and devaporation have discouraged their use in treating discharge streams from desalination of both seawater and brackish water. The methods, challenges, economics, and policy implications of concentrate disposal as well as it costs have been well documented.

ZLD systems are widely used in other industries and situations where liquid wastes cannot be discharged. These systems usually include evaporative brine concentration followed by crystallization or spray drying to recover solids. Common ZLD processes include the thermal brine concentrator and crystallizer. This technology can be used to separate the concentrate (brine) from seawater reverse osmosis (SWRO) processes into freshwater and dry salt. However, the capital costs and electrical consumption, approximately $6,000-$9,000 per cubic meter of daily capacity ($23-$34 per gpd and approximately 30 kilowatthours (kWh) per cubic meter) of freshwater produced, is so high that it has not been used to achieve “zero discharge” SWRO. Water removal from dilute brines is usually accomplished by vapor compression or high-efficiency, multiple-effect evaporators. The vapor then condenses in a heat exchanger that contacts the brine to form potable water with less than 10 ppm of total dissolved solids (TDS). Heat for evaporating water from saturated brines is usually provided by steam. Even with the efficiencies of vapor compression, the capital and operating costs of existing ZLD processes are substantial.

Additionally, the high TDS of the seawater feed constitutes a major problem to the SWRO process. It also constitutes a problem to the thermal processes since the degree of hardness increases as the seawater TDS is increased. As is generally known, in a normal osmosis process, a solvent naturally moves from an area of low solute concentration (high water potential), through a membrane, to an area of high solute concentration (low water potential). The movement of solvent is driven to reduce the free energy of the system by equalizing solute concentrations on each side of a membrane, generating osmotic pressure. Applying an external applied pressure to reverse the natural flow of pure solvent is reverse osmosis. From the principles of SWRO the applied pressure (Pₐₚₚₗ) is necessarily used to overcome the osmotic pressure (Pₒₛₘ) and the remaining pressure is the net pressure driving water through the membrane (Pₙₑₜ). Hence, the product water quantity (Qp) is directly related to Pₙₑₜ, and the less the osmotic pressure (Pₒₛₘ) the greater is the Pₙₑₜ and, therefore, the greater is the amount of pressure available to drive the permeate water through the membrane and the greater is the quantity of product, which in turn as shown later, lowers the process energy requirement. The effect of varying feed TDS on πfb feed-brine and Pₙₑₜ on the SWRO process at an applied pressure of 60 bar and final brine TDS of 66,615 ppm is shown in FIG. 1. The available useful Pₙₑₜ pressure to drive the water though the membrane, marked by the shaded area, increases as the feed TDS and, therefore, Δπfb feed-brine are decreased and vise-versa. The fraction of the Pₐₚₚₗ which equals Δπfb is considered to be a wasted energy (although it is necessary in the SWRO process). Since the permeate flow through the membrane is directly proportional to the Pₙₑₜ, any process that lowers the feed TDS not only reduces the wasted energy but it increases the fresh water permeation (Qp) through the membrane. However, since seawater has a high TDS, the amount of wasted energy is greater and fresh water permeation is lower in the SWRO process.

Apart from RO, electrodialysis is another process that has been used in desalination processes. Electrodialysis (ED) is an electrochemical process in which ions migrate through ion-selective semipermeable membranes as a result of their attraction to two electrically charged electrodes. ED is able to remove most charged dissolved ions. Ion-selective membranes that are able to allow passage of either anions or cations make separation possible. ED uses these membranes to create concentrate streams (a stream of liquid—water—including the charged dissolved ions) and product streams (treated water).

In Japan, electrodialysis (ED) has been used to recover salt (e.g. NaCl) from sea water on a large scale for about 40 years. The recovered salt is used in chlor-alkali plants to convert the salt to sodium hydroxide. Typically the energy consumption of an ED plant using the reject of a sea water reverse osmosis plant (as the source of water for treatment) is about 80% compared to using sea water as the source (Tanaka, Y., Ehara, R., Itoi, S., and Goto, T, “Using Ion-Exchange membrane electrodialytic salt production using brine discharged from a reverse osmosis sea water desalination plant”, J. Membrane Soc., 222, 71-86 (2003)).

Combining electrodialysis with reverse osmosis to produce NaCl and fresh water is disclosed in U.S. Pat. No. 6,030,535 and U.S. Pat. No. 7,083,730. However, in these processes that use electrodialysis with RO, fouling (e.g., plugging or clogging) of the membranes is a substantial problem. Fouling of reverse osmosis membranes by gypsum is well know, the gypsum being formed by the reaction of sulfate, which comprises 8 wt % of the total dissolved solids in sea water, with calcium being 1-1.5 wt %. Even with polarity reversal, the gradual buildup of calcium sulfate (insoluble) results in membrane fouling within the ED cells.

U.S. Pat. No. 6,030,535 discloses an ED membrane that is not permeable to sulfate to prevent gypsum formation in the ED concentrate stream. However, significant sulfate and calcium is recycled from the ED stream to the reverse osmosis system potentially creating gypsum scaling on the RO membranes. A large portion of the dilute ED stream, containing 2 wt % dissolved salt, must be taken to a discharge purge back to the sea to limit the calcium and sulfate concentration in the RO unit brine discharge stream.

U.S. Pat. No. 7,083,730 discloses partial soda ash softening of the feed sea water to remove most of the calcium to prevent gypsum scaling. However, this requires a significant amount of caustic and soda ash addition and produces a mixed calcium carbonate, magnesium carbonate softener sludge for disposal. This patent also discloses the separation of valuable magnesium hydroxide by using low cost lime or dolomitic lime. However, low cost lime or dolomitic lime contains significant amounts of gypsum, which would contaminate the magnesium hydroxide. The use of caustic is economically infeasible since the cost of caustic and magnesium hydroxide are almost the same, and approximately 1.4 tons of caustic is required to produce 1 ton of magnesium hydroxide.

Thus, even the processes described in these patents are not sufficient to prevent the buildup of compounds such as calcium sulfate and fouling of the membranes. This can be a significant problem because the fouling of membranes decreases the efficiency of the system, and requires downtime for cleaning or replacing membranes (along with the attendant added cost of new membranes for periodic replacement due to fouling).

### SUMMARY OF THE INVENTION

Certain exemplary aspects of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be explicitly set forth below.

The present invention overcomes issues with removing contaminants such as salts (e.g., sodium chloride) from water (such as sea water), such as those described in the Background. In one aspect of the present invention, removal of such contaminants (e.g., salts) is achieved by combining electrodialysis (ED) and reverse osmosis (RO) within apparatus and/or a system. The use of ED, in various aspects of the present invention, provides a novel method, apparatus, and system for separating ionic species from water using electrical forces. Once this separation is achieved, an organic solvent may be used to precipitate salts from the water. Once precipitation has occurred, other aspects of the present invention may include further processing to (1) remove the precipitated salt from the water, (2) remove the solvent from the water, and (3) further process the salt to recover materials (such as bromine and magnesium) that have value as a separate product or products (in order to offset any cost, or portion of the cost, of the water treatment).

Thus, one aspect of the present invention provides for at least one electrodialysis cell that can separate monovalent and multivalent ionic species from one another. In that regard, as is generally known, ED is used to transport salt ions from one solution through ion-exchange membranes to another solution under the influence of an applied electric potential difference. A typical ED cell includes a membrane configuration with alternating cation-selective and anion-selective membranes (the configuration of cation-selective and anion-selective membranes is often referred to as a membrane “stack”). The cation-selective membrane (cation-exchange membrane) permits only positive ions to migrate through it. And the anion-selective membrane (anion-exchange membrane) permits only passage to negatively charged ions. Electrodes (a cathode and an anode) are placed at each end of the membrane stack, supplying a well distributed electrical field of direct current across the membrane stack. Between every membrane, spacers are placed. Spacers make sure that there is room between membranes for liquid to flow along the membrane surfaces. Cations are carried towards the cathode, while anions are carried towards the anode. Thus, typical electrodialysis cells separate ions based on their charge. However, they do not have the ability to separate monovalent ions from multivalent ions (e.g., divalent ions).

In one aspect of the present invention, a new electrodialysis cell is provided. This ED cell does not include the typical ion exchange membranes. Rather, the ED cell includes an anode and a cathode, with a plurality of chambers therebetween. Each chamber of the plurality of chambers may be at least partially defined by a membrane (such that the ED cell includes a plurality of membranes—or a membrane “stack”), wherein at least one of those membranes allows passage therethrough of monovalent ions, but substantially prevents the passage therethrough of multivalent ions (e.g., divalent ions). In certain embodiments, at least two membranes allow passage therethrough of monovalent ions, while substantially preventing the passage therethrough of multivalent ions. In one embodiment, this membrane or membranes may be nanofiltration (NF) membranes. NF membranes allow for the separation of monovalent ionic species from multivalent ionic species (because monovalent species can pass through the NF membrane, but the larger multivalent species, and/or those of greater molecular weight, are prevented from doing so). Thus, use of the ED cell of this aspect of the present invention allows for the creation of at least two separate streams of liquid, one containing monovalent ionic species (without multivalent ionic species), and the other including multivalent ionic species (without monovalent ionic species). Such separated streams can then be processed separately to easily separate byproducts that have value (e.g., bromine from the monovalent stream, and magnesium from the multivalent stream), and can be sold to offset the cost of the water treatment process. This makes the process of the present application more cost-effective as compared to prior art processes.

As described above, once separation of monovalent and multivalent species is achieved, the two streams (one containing monovalent species, and one containing multivalent species) may be processed separately. In either process, salts in each stream of liquid may first be precipitated from the liquid. In one aspect, the present invention involves precipitating a salt or salts out of the liquid using a solvent. The solvent may be an organic solvent. To that end, ethanol precipitation is a widely used technique to purify or concentrate nucleic acids. In the presence of salt (in particular, monovalent cations such as sodium ions), ethanol efficiently precipitates nucleic acids. Nucleic acids are polar, and a polar solute is very soluble in a highly polar liquid, such as water. However, unlike salt, nucleic acids do not dissociate in water since the intramolecular forces linking nucleotides together are stronger than the intermolecular forces between the nucleic acids and water. Water forms solvation shells through dipole-dipole interactions with nucleic acids, effectively dissolving the nucleic acids in water. The Coulombic attraction force between the positively charged sodium ions and negatively charged phosphate groups in the nucleic acids is unable to overcome the strength of the dipole-dipole interactions responsible for forming the water solvation shells.

Adding a solvent, such as ethanol to a nucleic acid solution in water lowers the dielectric constant, since ethanol has a much lower dielectric constant than water (24 vs 80, respectively). This increases the force of attraction between the sodium ions and phosphate groups in the nucleic acids, thereby allowing the sodium ions to penetrate the water solvation shells, neutralize the phosphate groups and allowing the neutral nucleic acid salts to aggregate and precipitate out of the solution [as described in Pi\check{s}kur, Jure, and Allan Rupprecht, “Aggregated DNA in ethanol solution,” FEBS Letters 375, no. 3 (November 1995): 174-8, and Eickbush, Thomas, and Evangelos N. Moudrianakis, “The compaction of DNA helices into either continuous supercoils or folded-fiber rods and toroids,” Cell 13, no. 2 (February 1978): 295-306, the disclosures of which are incorporated by reference herein in their entireties].

Another aspect of the present invention, then, contemplates that the principles regarding the precipitation of nucleic acids via the introduction of water miscible solvents can also be used to precipitate soluble salts, which, like nucleic acids, have solvation shells formed around the ions. Thus, by lowering the dielectric constant of the solution, the Coulombic attraction between the oppositely charged ions can be increased to cause the neutral salts to precipitate out of solution. However, one must be able to correctly choose a solvent that will efficiently, and therefore cost-effectively, precipitate the particular salts that will be present in the water being treated. And so, another aspect of the present invention involves a method for determining how to choose an appropriate solvent. To that end, the selection of the solvent is based on the following analysis: First, the organic liquid should be miscible with saturated salt water at concentrations exceeding 50 vol %. Second, the organic liquid should have a viscosity less than 90 cP, so that it can be easily pumped through a membrane system for post-precipitation separation of the solvent from the liquid (although, if other methods of separation are used to separate the solvent from water—such as evaporation of solvent—then viscosity may not be an issue). And third, the organic liquid should have a low dielectric constant, so that when mixed with salt water, it lowers the dielectric constant of the solution enough to allow the water of hydration around the salt ions to be removed, thereby allowing the ions to combine to form neutral salt.

Once a salt or salts is/are precipitated out of solution, another aspect of the present invention involves removing the precipitated salt from the water. For example, in one embodiment, the precipitated salt may be removed from the water via use of apparatus such as hydrocyclones. And, once a salt or salts have been precipitated from the ED discharge stream including monovalent ions, or the ED discharge stream including multivalent ions, the salt(s) may be further processed to create saleable byproducts to offset or mitigate the cost of the water treatment system.

A further aspect of the present invention involves removing the solvent from the water. The solvent may be removed via multiple methods. For example, membranes may be used to remove the solvent. Such a method may include one membrane or multiple membranes. Further, such a method may include one or more of ultrafiltration membranes, nanofiltration membranes, and reverse osmosis in varying configurations. The membranes may also be used to separate a precipitated salt or salts from the water, as opposed to, or in addition to, removing solvent from the water.

Various other aspects of the invention regarding membrane separation may include (1) using the membrane systems described herein to reject solvent so that it is recaptured for reuse; and/or (2) using the solvent in solution to prevent fouling of a membrane or membranes being used in the process.

### BRIEF DESCRIPTION OF THE DRAWINGS

The accompanying drawings, which are incorporated in and constitute a part of this specification, illustrate embodiments of the invention and, together with the general description of the invention given above and the detailed description of the embodiments given below, serve to explain the principles of the present invention.

FIG. 1 is a graph showing the effect of varying feed TDS on πfb feed-brine and Pₙₑₜ on a seawater reverse osmosis process.

FIG. 2 is a schematic showing an overall system for the desalination of water (such as seawater) in accordance with principles of the present invention.

FIG. 3 is a detailed schematic of an electrodialysis cell (such as the cell shown in FIG. 2).

FIG. 4 is a schematic showing the principles of electrolysis and electrodialysis.

FIG. 5 is a schematic showing a standard configuration of a desalting process using the principles of electrodialysis.

FIG. 6 is a schematic showing an electrodialysis unit in accordance with principles of the present invention.

FIG. 7 is a schematic showing a system including sequential electrodialysis units.

FIG. 8 is a graph showing a plot of a fraction of salt precipitated from water using various amounts of ethylamine as the solvent.

FIG. 9A is a schematic showing an embodiment of a method and apparatus for precipitation of salt in accordance with the principles of the present invention.

FIG. 9B is a schematic showing an embodiment of a method and apparatus for precipitation of salt in accordance with the principles of the present invention, including an underflow degassing process and system for removal of solvent, among other materials.

FIG. 9C is a schematic showing an embodiment of a method and apparatus for the precipitation of salt in accordance with the principles of the present invention, including an overflow degassing process and system for removal of solvent, among other materials.

FIG. 10 is a schematic showing an embodiment of the precipitation process and system coupled with a membrane ultrafiltration process.

FIG. 11 is a schematic showing an embodiment of the precipitation process and system in conjunction with a membrane process and system.

FIG. 12 is a schematic showing an asymmetrical membrane with salt deposition within the membrane due to salt supersaturation conditions occurring within the membrane material.

FIG. 13 is a schematic showing an asymmetrical membrane with salt crystallization occurring outside the membrane as the solvent concentration in the water increases due to selective water permeation through the membrane.

FIG. 14 is a diagram showing how blockage of membrane pores may be prevented.

FIG. 15 is a schematic comparing flush cycles and membrane recovery in conventional (prior art) membranes versus membranes used in accordance with the principles of the present invention.

FIG. 16 depicts fouling in conventional (prior art) membranes.

FIG. 17 depicts the prevention of fouling in membranes in accordance with the principles of the present invention.

FIGS. 18A and 18B are cross-sectional views of an embodiment of apparatus used in separating solvent from a liquid (e.g., water) in the underflow and overflow degassing processes and systems depicted in FIGS. 9B and 9C.

FIG. 19 is a schematic of another embodiment of a precipitation process and system showing the use of a multi-effect distillation column system for separation of solvent.

FIG. 20 is an exploded view of a membrane cell.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present invention overcomes issues with removing contaminants such as salts (e.g., sodium chloride) from water (such as sea water), such as those described in the Background. In one aspect of the present invention, removal of such contaminants (e.g., salts) is achieved by combining electrodialysis (ED) and reverse osmosis (RO) within apparatus and/or a system. The use of ED, in various aspects of the present invention, provides a novel method, apparatus, and system for separating ionic species from water using electrical forces. Once this separation is achieved, an organic solvent may be used to precipitate salts from the water. Once precipitation has occurred, other aspects of the present invention may include further processing to (1) remove the precipitated salt from the water, (2) remove the solvent from the water, and (3) further process the salt to recover materials (such as bromine and magnesium) that have value as a separate product or products (in order to offset any cost, or portion of the cost, of the water treatment).

Thus, one aspect of the present invention provides for at least one electrodialysis cell that can separate monovalent and multivalent ionic species from one another. In that regard, as is generally known, ED is used to transport salt ions from one solution through ion-exchange membranes to another solution under the influence of an applied electric potential difference. A typical ED cell includes a membrane configuration with alternating cation-selective and anion-selective membranes (the configuration of cation-selective and anion-selective membranes is often referred to as a membrane “stack”). The cation-selective membrane (cation-exchange membrane) permits only positive ions to migrate through it. And the anion-selective membrane (anion-exchange membrane) permits only passage to negatively charged ions. Electrodes (a cathode and an anode) are placed at each end of the membrane stack, supplying a well distributed electrical field of direct current across the membrane stack. Between every membrane, spacers are placed. Spacers make sure that there is room between membranes for liquid to flow along the membrane surfaces. Cations are carried towards the cathode, while anions are carried towards the anode. Thus, typical electrodialysis cells separate ions based on their charge. However, they do not have the ability to separate monovalent ions from multivalent ions (e.g., divalent ions).

In one aspect of the present invention, a new electrodialysis cell is provided. This ED cell does not include the typical ion exchange membranes. Rather, the ED cell includes an anode and a cathode, with a plurality of chambers therebetween. Each chamber of the plurality of chambers may be at least partially defined by a membrane (such that the ED cell includes a plurality of membranes—or a membrane “stack”), wherein at least one of those membranes allows passage therethrough of monovalent ions, but substantially prevents the passage therethrough of multivalent ions (e.g., divalent ions). In certain embodiments, at least two membranes allow passage therethrough of monovalent ions, while substantially preventing the passage therethrough of multivalent ions. In one embodiment, this membrane or membranes may be nanofiltration (NF) membranes. NF membranes allow for the separation of monovalent ionic species from multivalent ionic species (because monovalent species can pass through the NF membrane, but the larger multivalent species, and/or those of greater molecular weight, are prevented from doing so). Thus, use of the ED cell of this aspect of the present invention allows for the creation of at least two separate streams of liquid, one containing monovalent ionic species (without multivalent ionic species), and the other including multivalent ionic species (without monovalent ionic species). Such separated streams can then be processed separately to easily separate byproducts that have value (e.g., bromine from the monovalent stream, and magnesium from the multivalent stream), and can be sold to offset the cost of the water treatment process. This makes the process of the present application more cost-effective as compared to prior art processes.

An overview of a system in accordance with principles of the various aspects of the present invention is as follows:

Overview of System for Separation of Salts from Water

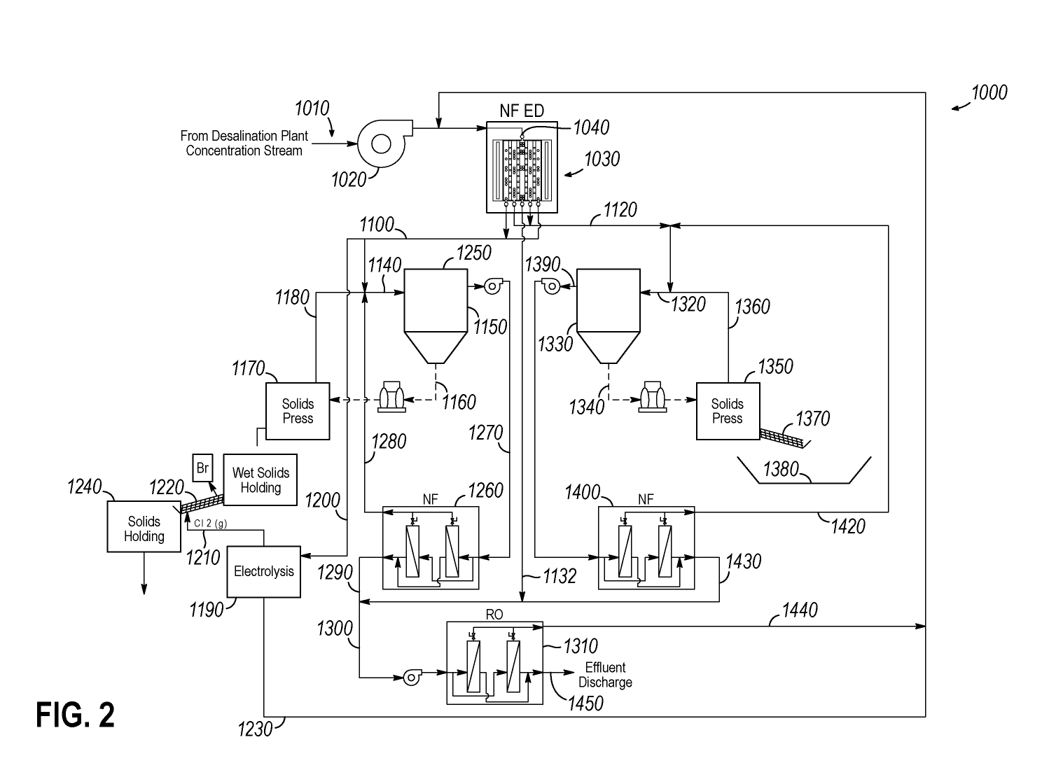

FIG. 2 shows one illustrated embodiment of an overall process and system 1000 for separation of materials, such as salts, from water, in accordance with principles of the present invention. The water to be treated may be seawater, or water from an existing treatment facility (e.g., water that has already undergone some treatment, or reject water from such treatment), or other saline water sources. Thus, type of water being treated (brackish, seawater, previously treated seawater, brine, industrial waste, etc.) is not necessarily relevant. However, the concentration of the contaminants (e.g., ionic contaminants) in the water/liquid may be a consideration in how to process/treat the liquid.

For purposes of this application, different types of water containing salt are listed in Table 1 (below). The apparatus, methods, and systems described herein can be practiced for any or all of the waters included in Table 1, although, for salt concentrations above 100,000 ppm, the use of electrodialysis (ED) generally becomes inefficient due to back diffusion of salt ions against the electrical gradient. Further, the solvent precipitation process generally can be used at salt concentrations above 80,000 ppm. One aspect of the present invention, however, is that various embodiments of the apparatus, method, and system may be used on water that has a salinity of less than 80,000 ppm (as noted above, seawater has a nominal salinity around 35,000 ppm, and discharge streams from seawater treatment plants have a salinity of around 70,000 ppm—as those plants, described above, can yield 50% freshwater). A first step, in such a situation, is to increase the salinity of the liquid coming into the system to 80,000 ppm or above, so it can be effectively treated. In certain embodiments, it will be useful to increase the salinity to 100,000 ppm or above. This is because one step of the process is to precipitate salts from the liquid using an organic solvent (as will be described in greater detail below). However, to effectively precipitate such salts, a high salinity concentration is useful. In one embodiment, reject streams of water from existing treatment systems/plants may be used. Reject streams of water from existing treatment systems generally have the following characteristics: (1) the water may be pretreated for organics, turbidity and for other contaminants; and (2) the water is already concentrated beyond original water concentrations. This enables the system in accordance with aspects of the present invention to expend less energy concentrating the influent water (i.e., source water).

TABLE 1
Relative Salinity of different types of water containing salt.

| General water term | Relative salinity, mg/l (ppm) TDS |
|---|---|
| Fresh Raw (natural) | Less than 1,000¹ |
| Brackish | 1,000 to 30,000 |
| Sea | 30,000 to 50,000 |
| Hypersaline | Greater than 50,000 or that found in the sea. |
| Natural Brine | Greater than 50,000 to slurries ² |
| Discharge Brine | 1,000 to slurries ³ |

¹Based on community drinking water standards. Salinity target values for municipal drinking water system using desalination technologies are typically less than 500 ppm TDS.
^{2.} Also, brines or “salines” naturally derived from groundwater are 100,000 ppm or greater TDS, NaCl saturated solutions are approx. 260,000 ppm in concentration.
^{3.} Discharge brine concentrations vary widely and are dependent upon technologies employed and processes used to discharge brine as a final waste stream to the environment. The concentration of reject water from a desalination facility may be referred to as “brine” but may only be 4,000 mg/l TDS in concentration.

If the water to be treated is already at or above a salinity of 100,000 ppm, then the water can be processed through a system such as that described in parent U.S. patent application Ser. No. 14/099,306, incorporated by reference herein in its entirety. However, if the concentration is below that 100,000 ppm level, or 90,000 ppm, or 80,000 ppm, then the organic solvent may not precipitate/separate the salts to the system's greatest efficiency. The system, as described in U.S. patent application Ser. No. 14/099,306, may be used to treat frac water, which is generally at a very high salt concentration, almost near saturation. As described above, sea water by itself and even the reject streams from current sea water desalination plants are typically at or below 70,000 ppm salt. And so, one aspect of the present invention is that water/liquids with such lower concentrations of contaminants can first have the concentration of contaminants increased so that they then can be subjected to a solvent precipitation process (with subsequent salt removal and solvent removal). The discussion of various salinity concentrations for the present system should not be taken as indicating that the system cannot operate with feed water with concentrations lower than the levels listed above.

However, in one embodiment of the present process, the concentration of contaminants in the feed water (i.e., the source water) is first concentrated further by the process/system. For example, if the feed water is reject water from a seawater treatment plant (having a salinity of 70,000 ppm), the water may first be subjected to a process to increase the salt concentration. One example/embodiment of an apparatus that can be used to increase the concentration is through an electrodialysis cell, which can include a membrane to allow monovalent ions to be separated from multivalent ions, as will be described in greater detail below.

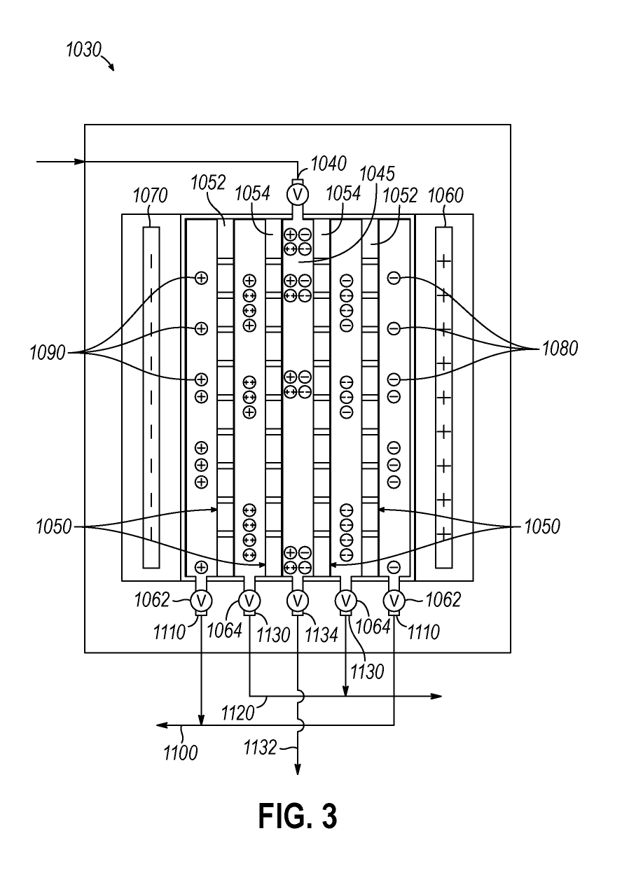

One embodiment of a system for separating salts from water is illustrated in FIG. 2. Referring to that figure, water enters the system 1000 at inlet 1010 via pump 1020. The flow path for water through the system 1000 is shown by the arrows in FIG. 2. After entering system 1000, water then enters at least one electrodialysis cell 1030 (a schematic of one embodiment of such a cell is shown in FIG. 3). The water enters the cell 1030 through an inlet 1040. The water then passes into a chamber 1045 including a plurality of membranes 1050. Certain of these membranes 1052 may allow passage therethrough of monovalent ions, but substantially prevent the passage therethrough of multivalent ions. In one embodiment, these membranes 1052 may be nanofiltration membranes. Nanofiltration is a cross-flow filtration technology which ranges between ultrafiltration and reverse osmosis in terms of pore size. The nominal pore size of the nanofiltration membrane may typically be about 1 nanometer in one embodiment. Nanofilter membranes may also be rated by molecular weight cut-off (MWCO) rather than nominal pore size. The MWCO is typically less than 1000 atomic mass units (daltons). Nanofiltration membranes have a pore size and/or MWCO such that monovalent ions may pass through the membrane, whereas the larger multivalent ions, such as divalent ions, cannot pass through the membrane.

Within the ED cell 1030, an anode 1060 and a cathode 1070 are present to attract negative ions 1080 and positive ions 1090, respectively, to separate sides of the cell 1030. Negative ions 1080 desire to pass through the membranes 1050 to the anode 1060, due to the attraction between the negatively charged ions and the positively charged anode. And positive ions 1090 desire to pass through the membranes to the cathode 1070, due to the attraction between the positively charged ions and the negatively charged anode 1060. As described above, certain membranes 1050 may be nanofiltration membranes. (For example, to ensure that not only monovalent and multivalent species are separated, but that also positive and negative species are separated, the two center membranes 1054 may be typical ion-selective membranes, or ultrafiltration membranes—but not nanofiltration membranes.) Multivalent ions (e.g., divalent ions) cannot pass through the nanofiltration membrane due to size or molecular weight in excess of the membrane pore size or MWCO, and therefore do not migrate to the anode and cathode sides of the reactor (see FIG. 6). Thus by providing a plurality of membranes, at least some of which are nanofiltration membranes as in the illustrated embodiment, one may provide an ED cell where liquid (water) containing monovalent ions is separated from liquid (water) containing multivalent ions. More specifically, as can be seen from FIGS. 2 and 3, the ED cell may include at least fluid having monovalent positive ions, fluid having monovalent negative ions, fluid having multivalent positive ions, and fluid having multivalent negative ions. In the illustrated embodiment, the fluids having the positive and negative monovalent ions are combined into a single stream 1100 of monovalent ions exited from the ED cell, and the fluids having the positive and negative multivalent ions are combined into a single stream 1120 of multivalent ions exited from the ED cell. These separate fluids may then be removed from the cell via different outlets and processed separately. For example, in the illustrated embodiment, three flows exit the electrodialysis cell: (1) a flow of monovalent ions 1100 exit at outlet(s) 1110, (2) a flow of divalent ions 1120 exit at outlet(s) 1130, and (3) a flow of water having a low concentration of ions 1132 exits at outlet 1134.

Thus, there are two discharge streams 1100, 1120 from the ED cell in FIG. 2 that include separated ions: one with monovalent ions, and one with multivalent ions. Discharge stream 1100, as shown in FIG. 2, is a stream of monovalent ions, and this stream, in certain embodiments, may be manipulated to have a greater concentration of ions than the concentration in the discharge stream including multivalent ions. To that end, in one embodiment of the electrodialysis cell, the outlets 1110 may allow for restricted flow of fluid therethrough. One way this may be accomplished is via the use of a valve or valves. Thus, less water moves through the outlet(s), which means the monovalent concentration in those streams 1100 (and ultimately in the combined positive/negative monovalent stream) is increased over the concentration in the divalent streams 1120 and combined streams (which, in certain embodiments, are not subjected to restricted fluid flow).

More specifically, it may be useful, in certain embodiments, to increase the concentration of the monovalent ions in the monovalent stream of flow 1100 prior to having that flow enter the reactor/settler tank 1050. Again, this is in order to increase the ability of the organic solvent in the tank 1050 to precipitate salts. Once the positive monovalent ions in water in the ED cell 1030 are combined with the negative monovalent ions in water in the ED cell (this combination occurring in the monovalent stream 1100), the positive and negative monovalent ions will be combined and can form salts—e.g., Na⁺ may be present and Cl⁻ may be present, and when the liquids containing them are combined in stream 1100, they may form NaCl in solution, or when the ions are introduced to a solvent, they may combine to form NaCl and precipitate out of solution. However, the higher the concentration of the NaCl in solution, the higher the percentage of NaCl that precipitates once introduced into the tank 1050 including organic solvent.

However, those skilled in the art should note that the step of increasing the concentration of the monovalent ions passing through the ED cell is not necessary for the operation of all embodiments of the system. This is because, as described above, after precipitation of any salt occurs, the water being treated is further subjected to a membrane separation process, which may include a reverse osmosis membrane or membranes. Reverse osmosis membranes will reject any monovalent ions that are in the water, and so, even at a lower concentration of monovalents, the water can still be treated, because the reverse osmosis membrane(s) will reject any of the monovalent species that do not precipitate. However, a lower amount of total dissolved solids (e.g., salts) in the stream that is introduced to the reverse osmosis membrane(s) will provide greater capacity for the reverse osmosis membrane(s) to effectively function. In other words, the membranes, and thus the system may function more efficiently if the monovalent species are first concentrated to promote precipitation. However, the system can work either way.

While the discussion above (and below) describes steps and apparatus to increase the concentration of monovalent species in a flow 1100, it is also possible to increase the concentration of multivalent species in flow 1120. Like the flow containing monovalent species, this may be done to allow the multivalent species to more effectively precipitate in reactor/settler tank 1330. However, as the membranes in system 1000 that the multivalent flow 1120 will be subjected to include both nanofiltration membranes and reverse osmosis membranes, the ability of the membrane portion of the system to effectively and efficiently remove multivalent species is better than the ability to remove monovalent species (because both nanofiltration membranes and reverse osmosis membranes will reject multivalent species—nanofiltration membranes will not reject monovalent species).

With the above described alternatives to the system, and use thereof, in mind, a more detailed discussion of exemplary processes that may be used to concentrate monovalent species within a liquid follows: With reference to FIG. 3, to cause the concentration of monovalent species in the stream 1100 exiting the ED cell to be increased, in one embodiment, valves 1062 may be positioned at each of the monovalent outlets 1110. The valves 1062 may be adjustable, and may be kept open, though kept at a diameter that restricts the amount of water that flows out. With a lower amount of water flowing out of the outlets 1110, the monovalent species increase in concentration within the chambers of the ED cell 1030, and thus within the stream 1100 exiting the ED cell 1030. The valves 1062 may be self-regulating in order to prevent the concentration of monovalent species within the ED cell and within the stream 1100 from getting too high (e.g., so high that they may reach their solubility limit, and precipitation prematurely occurs). If one knows the various species (elements, compounds, etc.) that are present in feed water, one can determine the solubility of those species, and thus the concentration at which saturation is achieved and precipitation begins to occur. By keeping the valves 1062 such that the concentration of monovalent species does not rise above the lowest of the solubilities of the species in the flow, one can prevent precipitation within the ED cell or stream 1100. Saturation concentrations are widely known and readily discoverable. The valve may also include a control system providing the ability to sense and monitor concentration in real time, such that the valve can adjust as necessary in response to a sensed concentration. One such type of valve and control system is a proportional-integral-derivative controller (PID controller) which is a control loop feedback mechanism (controller) widely used in industrial control systems, and thus is known to those skilled in the art.

FIG. 3 also shows valves 1064 associated with the outlets 1130 for chambers within the ED cell 1030 that include multivalent ions. These valves may include the same or similar components, and operate in the same or similar fashion, as the valves 1062 described above with respect to the chambers including monovalent species. Those of skill in the art will also recognize that if one does not wish to increase the concentration of monovalent species, or multivalent species, or both, one may simply leave open any valves desired.

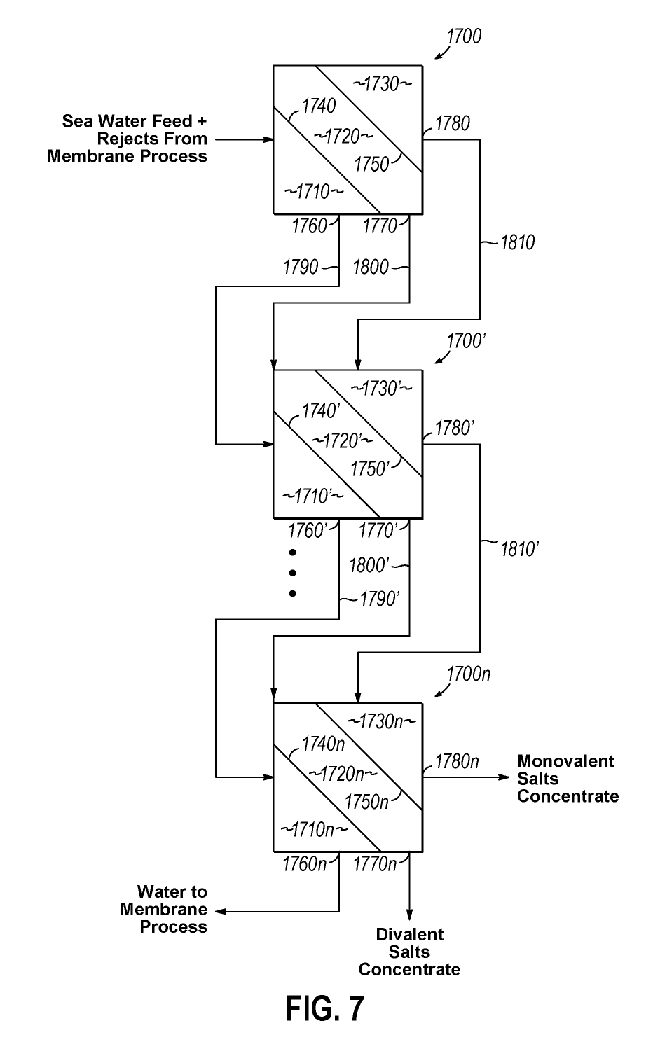

The above description is for the one ED cell shown in FIG. 3. Multiple ED cells may be used individually, or multiple ED cells may be used sequentially. The use of multiple ED cells sequentially is shown in FIG. 7. The use of multiple cells may also be used to concentrate the monovalent species and divalent species in exit streams, as will be described in greater detail below.

As depicted in FIG. 2, the system 1000 of the illustrated embodiment includes a single ED cell. However, it will be recognized by those of ordinary skill in the art that the figure is merely an example of such a system, and the number of cells shown is not limiting. Thus, embodiments of the system 1000 may include multiple ED cells (as will be described below with reference to FIG. 7). Further, as depicted in FIGS. 2 and 3, the ED cell is shown as having four membranes. However, it will be recognized by those of ordinary skill in the art that the figure is merely an example of such a cell, and the number of membranes shown is not limiting. Thus, embodiments of the system 1000 may include four membranes, or may include more or less than four membranes.

After exiting the ED cell 1030, stream 1100 enters stream 1140 where it enters a first reactor/settler tank 1150 (for the monovalent stream). The concentrated stream of monovalent ions are introduced to an organic solvent in reactor 1150 via stream 1140. The organic solvent is supplied from an external source (not shown in FIG. 2). Further, during cycling of the liquid (water through the system) there will be small losses of the organic solvent, and so the external source is used to continuously replenish the solvent delivered to the reactor/settler tank 1150. Once the water is exposed to the solvent in the reactor settler tank 1150, saturation conditions change, since the saturated salt concentration in the organic-water solution is much less than the saturated salt concentration in water alone, and the monovalent ions precipitate and settle to the bottom of the reactor/settler tank 1150.

Dwell time is provided by the settling tank for (1) crystal growth (as crystals grow they gain mass and settle), and (2) settling time (crystals with significant mass need time un-agitated to settle). Following this dwell time, the outlet flow from the settling tank will be made up of at least (1) solids that have not reached enough mass to settle in the provided dwell time provided by the settling tank, and (2) water with a high concentration of solvent. These will be removed from the tank 1150 at separate locations on the tank 1150. To that end, once precipitation of salt occurs, precipitated salts will settle to the bottom of the tank 1150 while water including solvent and low salt concentration will be present near the top of the tank 1150. Precipitated salt can be removed from the bottom of the tank and processed, and water can be removed from the top of the tank and separately processed.

Turning first to the processing of precipitated salt: As described above, there are various salts that may be present in the water being treated, and certain of those may have value that makes them candidates to be isolated and sold as byproducts in order to mitigate or offset the cost of operation of the system. For example, BrSO₄ is present in seawater and can be precipitated in the system 1000 and processed to make a saleable by-product: Bromine (Br₂). To that end, Br and SO4 will be separated within the ED cell, and when passing out of the streams Br— will be combined with Na+ to form NaBr in the monovalent stream, and in that stream, it will also be mixed with NaCl (due to the presence of NaCl in the stream because of the Na+ and Cl— ions that will come out of the ED cell(s)). Slurry (i.e., the water with precipitated salt) that exits the bottom of the reactor tank 1150 is pumped in a stream 1160 to a solids press/centrifuge system 1170 whereby solids are flushed and dewatered to a point where the solvents for reactor 1150 are returned through stream 1180 back to the reactor 1150 for reuse. More specifically, separation of the solid precipitates is achieved by a filter, wherein the wet precipitate is flushed several times with the liquid to wash any organic solvent out of the solid precipitate. Methods such as this to separate the solid precipitates in a solids press/centrifuge system are known, and have been used in the prior art. The solids are then directed to a screw press 1220 to be further processed.

Separately from the solids press 1170, an electrolysis cell 1190 is fed by a stream 1200 (from the original monovalent species stream 1100), which includes monovalent ions (mostly being NaCl—because, as described above, the positive Na ions and the negative Cl ions are recombined into the single stream 1100 as they exit the ED cell 1030.) A reaction then takes place that introduces NaOH to the liquid. More specifically, NaOH is formed by electrolysis of salt (NaCl) water, in which chlorine gas is liberated on the electrode, while OH⁻ remains behind in the solution, resulting in the formation of NaOH from the positive Na⁺ ions and negative OH⁻ ions (the electrolysis process is a general process know to those skilled in the art—a schematic of which is shown in FIG. 4). The freed chlorine gas (Cl₂) is directed through a stream 1210 to the screw press 1220 (the same screw press 1220 containing the solids described above) where the chlorine gas will react with those solids to form Br₂ gas:

NaBr+Cl₂→NaCl+Br₂ (gas)

The Br₂ is then condensed as a liquid for sale as a product. Other gases released in the process may be disposed of. Solids that pass through the screw press 1220 are stored in holding tank 1240 for disposal. Should salt or other solids become a sellable by-product, they will be cleaned and sold.

High pH water (e.g., including high levels of NaOH) is fed back to the inlet 1040 of electrodialysis cell 1030 via stream 1230 to increase the pH of the water in the electrodialysis cell. Increasing pH in the water to the ED system allows materials such as silicon and boron in the water to be removed. This is because one problematic issue is the buildup of boron in water exiting the ED cell (which will eventually be sent to the membranes—e.g., nanofiltration and reverse osmosis—described below). Boron is present in sea water as uncharged boric acid that typically must be removed at least at the 90% level to produce drinking water and/or agricultural water to meet the World Health Organization guideline of 0.5 ppm of boron. Since boron is uncharged, it will not be separated in the ED cell because it won't be attracted to an electrode. And so it will simply exit the ED cell 1030 in stream 1132, which proceeds directly to reverse osmosis membranes. And, because of its uncharged nature, it will cross the reverse osmosis membrane (seen at 1310) and thus would be present in the treated water exiting the system. This would be unacceptable. A similar problem is presented by silica in sea water.

However, by increasing the pH of the water in the ED cell by supplementing it with high pH water produced by electrolysis of the NaCl solution, both silicon and boron can be ionized, which in turn causes them to be separated in the ED cell. This allows the borate and silicates to be concentrated with the other ions in the ED monovalent stream. And, this allows the ions to go to the monovalent reactor/settler tank 1150 and precipitate out as a solid in the presence of the organic solvent. Methods of raising the pH of a liquid to 10-10.5 to convert uncharged boric acid to monovalent borate, and uncharged silica is converted to monovalent silicate is taught in U.S. Pat. Nos. 4,298,442, 5,250,185, and 5,925,255, incorporated by reference herein in their entireties.

Apart from the processing of the precipitated salts, the water of lower concentration salts (which is near the top of the tank 1150) may be treated separately. To that end, after solids settle in the monovalent reactor 1150, water lower in monovalent ions exits reactor 1150 at outlet 1250 and goes to a nanofiltration portion of the system 1000. In this portion of the system, at least one nanofilter 1260 receives water via stream 1270 from the reactor 1150. Herein, the nanofilters have been described as “nanofilter,” “nanofilters,” or “nanofilter(s).” As will be appreciated, this portion of the system 1000 may include at least one nanofilter, but may include more than one nanofilter that water may sequentially encounter. Solvent in this water is separated from the water by the nanofilter 1260 or nanofilters. Thus, following introduction of stream 1270 to nanofilter(s) 1260, water substantially free of solvent passes through nanofilter(s), while the reject stream from the nanofilter(s) will include solvent rich water. The solvent rich water returns to reactor 1150 via stream 1280 to assist in precipitation of further salts (from new water entering the tank 1150 from ED cell 1030). The water with solvent removed leaves nanofilter 1260 via stream 1290 and joins stream 1300 that feeds a reverse osmosis membrane 1310. Processing of water via reverse osmosis membrane or membranes 1310 will be described following a discussion of treatment of stream 1120 including multivalent species.

And so, turning now to the discharge stream including multivalent (e.g. divalent) ions: After exiting the ED cell 1030, stream 1120 enters stream 1320 where it enters a second reactor/settler tank 1330 (for the multivalent stream). The stream of multivalent ions is introduced to an organic solvent in tank 1330 via stream 1320. The organic solvent is supplied from an external source (not shown in FIG. 2). Further, during cycling of the liquid (water through the system) there will be small losses of the organic solvent, and so the external source is used to continuously replenish the solvent delivered to the reactor/settler tank 1330. Once the water is exposed to the solvent in the reactor settler tank 1330, saturation conditions change, since the saturated salt concentration in the organic-water solution is much less than the saturated salt concentration in water alone, and the divalent ions precipitate and settle to the bottom of the reactor 1330.

Dwell time is provided by the settling tank for (1) crystal growth (as crystals grow they gain mass and settle), and (2) settling time (crystals with significant mass need time un-agitated to settle). Following this dwell time, the outlet flow from the settling tank will be made up of at least (1) solids that have not reached enough mass to settle in the provided dwell time provided by the settling tank, and (2) water with a high concentration of solvent. These will be removed from the tank 1330 at separate locations on the tank 1330. To that end, once precipitation of salt occurs, precipitated salts will settle to the bottom of the tank 1330 while water including solvent and low salt concentration will be present near the top of the tank 1330. Precipitated salt can be removed from the bottom of the tank and processed, and water can be removed from the top of the tank and separately processed.

Turning first to the processing of precipitated salt: As described above, there are various salts that may be present in the water being treated, and certain of those may have value that makes them candidates to be isolated and sold as byproducts in order to mitigate or offset the cost of operation of the system. For example, MgSO₄ is present in seawater and can be precipitated in the system 1000 and processed to make a saleable by-product: Magnesium. A process for obtaining magnesium from precipitated salts is disclosed in U.S. Pat. No. 2,405,055, incorporated by reference herein in its entirety. Referring to FIG. 2, in general, slurry (i.e., the water with precipitated salt) that exits the bottom of the reactor/settler tank 1330 is pumped in stream 1340 to a solids press/centrifuge system 1350 whereby solids are flushed and dewatered to a point where solvents for reactor 1330 are returned through stream 1360 back to the reactor tank 1330 for reuse. More specifically, separation of the solid precipitates is achieved by a filter, wherein the wet precipitate is flushed several times with the liquid to wash any organic solvent out of the solid precipitate. Methods such as this to separate the solid precipitates in a solids press/centrifuge system are known, and have been used in the prior art. The solids are then directed to a screw press 1220 to be further processed. Solids that pass through screw press 1370 are stored in holding tank 1380 for disposal. Should multivalent salts or other solids become a saleable by-product, they will be cleaned and sold.

Thus, for example, addition of the electrodialysis cell(s) (ED stack) increases the cost of the system (via additional apparatus, and the electricity needed to perform the electrodialysis function). However, this cost can be offset because the system allows for separation of monovalents from multivalent, and thus byproducts (bromine and MgSO₄, for example) can be obtained from the waste streams to be sold to recoup the extra cost.

Apart from the processing of the precipitated salts, the water of lower concentration salts (which is near the top of the tank 1330) may be treated separately. To that end, after solids settle in multivalent reactor tank 1330, water lower in multivalent ions exits reactor 1330 at outlet 1390 and proceeds to a nanofiltration portion of the system 1000 (which operates in similar fashion to first NF portion described above). At least one nanofilter 1400 receives water via stream 1410 from reactor 1330. Solvent in this water is separated from the water by the nanofilter 1400 or nanofilters. Thus, following introduction of stream 1410 to nanofilter(s) 1400, water substantially free of solvent passes through the nanofilter(s), while the reject stream from the nanofilter(s) will include solvent rich water. The solvent rich water returns to reactor 1330 via stream 1420 to assist in precipitation of further salts (from new water entering the tank 1330 from ED cell 1030). The NF filter 1400 also rejects any multivalent ions still in the stream 1410, and those ions also flow via stream 1420 back to reactor 1330 to be concentrated in reactor 1330. The water with solvent removed leaves nanofilter 1400 via stream 1430 and joins stream 1300 that feeds the RO filter 1310.

Stream 1300 that feeds the RO filter 1310 is the same stream that includes water with solvent removed from the “monovalent side” of the system, which joins stream 1300 via stream 1290. Thus, each of streams 1290, 1430 includes water that has been processed to precipitate salts therefrom (using organic solvent) and subjected to a membrane system (e.g., nanofiltration membranes) to remove solvent. Stream 1300 that feeds the RO filter 1310 is also joined by stream 1132, which runs directly from an outlet 1134 of the ED cell. As can be seen in FIG. 3, stream 1132 flows out from center chamber of ED cell 1030. Center chamber is also the chamber that includes inlet 1040 to initially receive feed water 1010. As described above, when an electric current is applied across the ED cell 1030, monovalent and multivalent species move out of the center chamber and into adjoining chambers. Thus, water remaining in the center chamber (which exits via outlet 1134) should be substantially free of (or at a very low concentration of) ionic contaminants. And so, water exiting this chamber does not need to be subjected to solvent precipitation and subsequent membrane separation of solvent, but rather can proceed directly via stream 1132 to stream 1300 or reverse osmosis membrane(s) 1310. RO filter 1310 removes the remainder of the monovalent and divalent ions from the combined water. A concentrated stream of ions (i.e., any remaining ions removed by the RO filter) returns to the electrodialysis cell 1030 via stream 1440. Treated and clean water leaves the system 1000 via stream 1450.

Now that an embodiment of an overall system has been described, each of the components and steps of the process and system will be explained in greater detail.

Electrodialysis (ED) Unit

Electrodialysis (ED) is a process that may be used to desalinate or concentrate a liquid process stream containing salts (as described in the Background). ED is a highly efficient method for separating and concentrating salts. It is also very useful to reduce salt contents of process streams with high amounts of salts. Electrodialysis differs from pressure-driven membrane processes by utilizing electrical current as the main driving force in matter separation. This limits the possible solutes targeted for recovery separation to charged particles. The charged particles must be mobile, and the separation media must be able to transfer the electrical current with relatively low resistance. Electrodialysis is almost exclusively carried out on liquids. The principle of electrodialysis is related to electrolysis as shown in FIG. 4. A general difference between electrodialysis and electrolysis is that electrodialysis uses an ion-permeable membrane to separate the charged plates of the ionization chamber. In electrolysis, the anode and cathode plates are in the same chamber. In simple electrolysis, the alkaline water (made at the cathode plate) and the acidic water (made at the anode plate) are not separated.

When utilizing ion-exchange membranes to prevent the migrating cations and anions from reaching the electrodes, the ion exchange membranes can be employed to concentrate process streams, separate ionic species from nonionic species, or recover or extract charged solutes from waste streams.

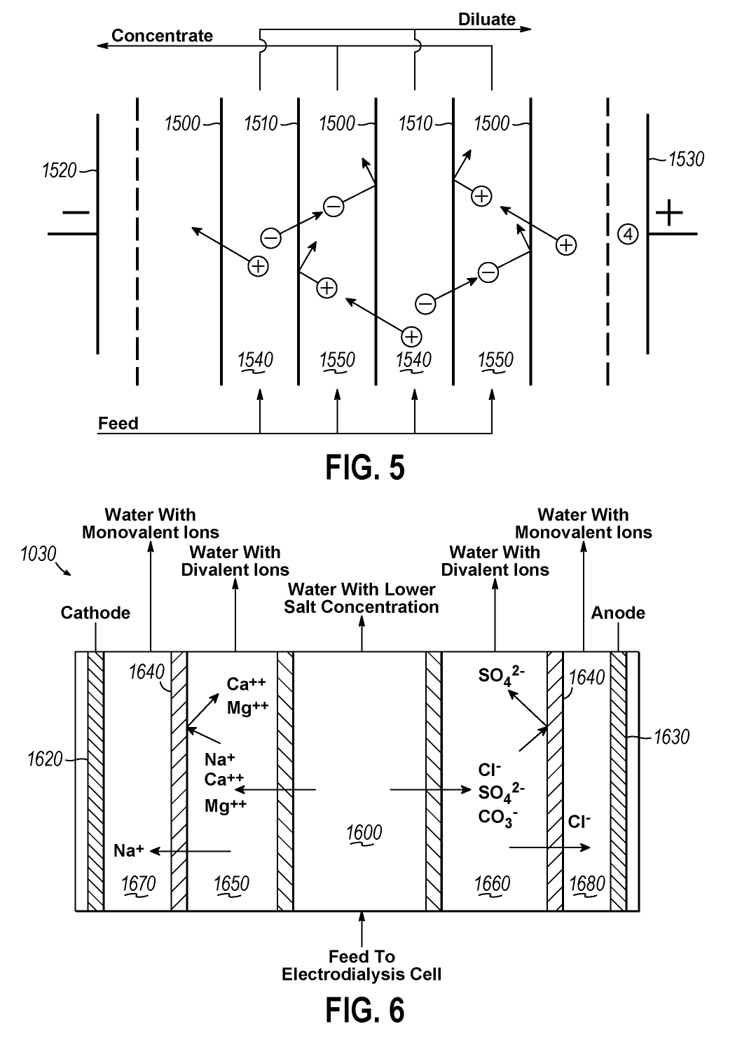

And so, a standard configuration of a desalination process utilizing the principles of electrodialysis is shown in FIG. 5. In other words, FIG. 5 shows an electrodialysis cell of the prior art. The drawing shows a membrane configuration with alternating cation-selective membranes 1500 and anion-selective membranes 1510. A cation-selective membrane (cation-exchange membrane) permits only positive ions to migrate through it. An anion-selective membrane (anion-exchange membrane) permits only passage to negatively charged ions. At each end of the membrane stack, electrodes (a cathode 1520 and an anode 1530) are placed, supplying a well distributed electrical field of direct current across the membrane stack. Between every membrane, spacers are placed. Spacers make sure that there is room between membranes for the liquid process streams to flow along the membrane surfaces. Cations are carried towards the cathode, while anions are carried towards the anode. The cations in chambers 1540 are able to migrate through the cation-selective membrane 1500 into the next chamber(s) 1550. In these flow chambers, the cations are trapped, unable to migrate through the anion selective membrane 1510. The anions in the flow chambers are able to migrate towards the anode 1520 through the anion-selective membrane 1510 and into the alternating flow chambers. In these flow chambers the anions are trapped, unable to migrate further, since they are faced with a cation-selective membrane 1500. The two electrodes are kept separated from the processed solutions.

Thus, cations and anions are migrating out of every second flow chamber into the remaining chambers. The result is that by collecting the outlet of the flow chambers, a depleted solution (i.e., a solution having ions removed) and an enriched solution (i.e., a solution having ions concentrated) are created.

In contrast to the ED cell(s) of the prior art, the electrodialysis (ED) unit 1030, in accordance with aspects of the present invention, is shown in FIGS. 3 and 6. Referring to FIG. 6, water flows into a central section 1600, which is separated from the other sections using porous plates 1610, through which ions and water can flow freely. The voltage force applied by the electrodes 1620, 1630 causes the positive and negative ions to move towards the opposite charged electrodes, as described above. At least one membrane 1640 (such as a nanofiltration membrane) is used to prevent the migration of the divalent species, which causes the divalent species, such as sulfate, calcium, magnesium, etc. (Ca⁺⁺, Mg⁺⁺, SO₄⁻⁻), to concentrate in sections 1650, 1660 proximal to central section 1600, while monovalent ions, such as sodium, chloride, and carbonate (Na⁺, Cl⁻, CO₃⁻), pass through the nanofiltration membranes, and end up concentrating in the sections 1670, 1680 proximal to electrodes 1620, 1630 of each ED cell.

The system including the ED cell(s) splits the feed flow into a multivalent ion stream (positive and negative) and a monovalent ion stream (positive and negative) flowing in separate sections of the system. The ED system may be a vertical, rectangular system, with vertical electrodes at opposite ends of the rectangular vessel, in which the two electrodes are insulated from each other. As the feed flows upwards, it splits into five separate streams (positive multivalent, negative multivalent, positive monovalent, negative monovalent, and water with reduced ions). The ED system can be stacked (with multiple cells), as shown in FIG. 7, to produce concentrated monovalent (positive and negative) streams, and concentrated multivalent streams (positive and negative), together with water with reduced salt concentration.

To that end, and referring to FIG. 7, a number of ED cells in sequential series are shown. While there are three ED cells specifically shown in the Figure, the three vertical dots represent that any number of additional ED cells may be present within the sequence. It should also be noted that in the ED cells described above (for example, with respect to FIGS. 3 and 6) it was shown that water was separated into chambers including positive monovalent species and positive multivalent species on the anode side of the ED cell, and negative monovalent species and negative multivalent species on the cathode side of the ED cell. However, the schematic shown in FIG. 7 only shows one side (either positive or negative) of the ED cell—though it will be recognized by those skilled in the art that the principles described below will apply to both sides (positive and negative) of the ED cell.

Thus, FIG. 7 shows a first ED cell 1700 including a first chamber 1710 into which feed liquid (such as any of the liquids described above—e.g., seawater, reject streams from seawater treatment facilities, etc.) enters. The ED cell 1700 also includes a second chamber 1720 and a third chamber 1730, the chambers being at least partially defined by one or both of a first membrane 1740 and a second membrane 1750. The first membrane 1740 may be an ultrafiltration membrane, such that both monovalent and multivalent species pass through the first membrane 1740 and into the second chamber. The second membrane 1750 may be a nanofiltration membrane, such that monovalent species pass through the second membrane 1750 and into the third chamber 1730, while the multivalent species are prevented from doing so (as they cannot pass through the nanofiltration membrane). Thus after water enters the first ED cell 1700, and is subjected to an electrical current (not shown in FIG. 7), (1) the first chamber 1710 will include feed water having a low concentration of monovalent and multivalent species (because the electric current will have moved those species out of the first chamber); (2) the second chamber 1720 will include multivalent species; and (3) the third chamber 1730 will include monovalent species. The first ED cell 1700 also includes first, second, and third outlets 1760, 1770, 1780, respectively associated with the first, second, and third chambers 1710, 1720, 1730. Once the water passes out of the ED cell from each chamber, it is directed via multiple flow paths to a second ED cell 1700′ (water from first chamber 1710 exits via first outlet 1760 to first flow path 1790, water from second chamber 1720 exits via second outlet 1770 to second flow path 1800, and water from third chamber 1730 exits via third outlet 1780 to third flow path 1810.

First, second, and third flow paths 1790, 1800, 1810 then enter second ED cell 1700′. More specifically, first flow path 1790 enters first chamber 1710′, second flow path 1800 enters second chamber 1720′, and third flow path 1810 enters third chamber 1730′. The second chamber 1720′ and third chamber 1730′ are at least partially defined by one or both of a first membrane 1740′ and a second membrane 1750′. The first membrane 1740′ may be an ultrafiltration membrane, such that both monovalent and multivalent species pass through the first membrane 1740′ and into the second chamber. The second membrane 1750′ may be a nanofiltration membrane, such that monovalent species pass through the second membrane 1750′ and into the third chamber 1730′, while the multivalent species are prevented from doing so (as they cannot pass through the nanofiltration membrane). Thus after water enters the second ED cell 1700′, and is subjected to an electrical current (not shown in FIG. 7), (1) the first chamber 1710′ will include feed water having a low concentration of monovalent and multivalent species (because the electric current will have moved those species out of the first chamber); (2) the second chamber 1720′ will include multivalent species; and (3) the third chamber 1730′ will include monovalent species. Additionally, the water in second chamber 1720′ and third chamber 1730′ of second ED cell 1700′ will have higher concentrations of multivalent and monovalent species respectively, since the starting point for those chambers is the water already received from first ED cell 1700, and then further multivalent and monovalent species will be added into those chambers 1720′, 1730′ from the remaining ionic species in water in first chamber 1710′ that were not separated out in first ED cell 1700. Thus, it will be recognized that the water in first chamber 1710′ of second ED cell 1700′ will have a lower concentration of ionic species than the water in first chamber 1710 of first ED cell 1700 (once electrical current has been applied and separation of monovalent and multivalent species effected). The second ED cell 1700′ also includes first, second, and third outlets 1760′, 1770′, 1780′, respectively associated with the first, second, and third chambers 1710′, 1720′, 1730′. Once the water passes out of the ED cell from each chamber, it is directed via multiple flow paths to a further ED cell 1700n (water from first chamber 1710′ exits via first outlet 1760′ to first flow path 1790′, water from second chamber 1720′ exits via second outlet 1770′ to second flow path 1800′, and water from third chamber 1730′ exits via third outlet 1780′ to third flow path 1810′.

First, second, and third flow paths 1790′, 1800′, 1810′ then enter further ED cell 1700n. More specifically, first flow path 1790′ enters first chamber 1710n, second flow path 1800′ enters second chamber 1720n, and third flow path 1810′ enters third chamber 1730n. The second chamber 1720n and third chamber 1730n are at least partially defined by one or both of a first membrane 1740n and a second membrane 1750n. The first membrane 1740n may be an ultrafiltration membrane, such that both monovalent and multivalent species pass through the first membrane 1740n and into the second chamber 1720n. The second membrane 1750n may be a nanofiltration membrane, such that monovalent species pass through the second membrane 1750n and into the third chamber 1730n, while the multivalent species are prevented from doing so (as they cannot pass through the nanofiltration membrane). Thus after water enters the further ED cell 1700n, and is subjected to an electrical current (not shown in FIG. 7), (1) the first chamber 1710n will include feed water having a low concentration of monovalent and multivalent species (because the electric current will have moved those species out of the first chamber); (2) the second chamber 1720n will include multivalent species; and (3) the third chamber 1730n will include monovalent species. Additionally, the water in second chamber 1720n and third chamber 1730n of further ED cell 1700n will have higher concentrations of multivalent and monovalent species respectively, since the starting point for those chambers is the water already received from second ED cell 1700′, and then further multivalent and monovalent species will be added into those chambers 1720n, 1730n from the remaining ionic species in water in first chamber 1710n that were not separated out in second ED cell 1700′. Thus, it will be recognized that the water in first chamber 1710n of further ED cell 1700n will have a lower concentration of ionic species than the water in first chamber 1710′ of second ED cell 1700′ (once electrical current has been applied and separation of monovalent and multivalent species effected). The further ED cell 1700n also includes first, second, and third outlets 1760n, 1770n, 1780n, respectively associated with the first, second, and third chambers 1710n, 1720n, 1730n. Water passes out of the further ED cell 1700n from each chamber as a monovalent salt concentrate (from third chamber 1730n), a multivalent salt concentrate (from second chamber 1720n), and low concentration water (from first chamber 1710n). The monovalent and multivalent concentrated streams may then progress to individual reactor settler tanks (such as those shown in FIG. 2) for the remainder of the system 1000. The low concentration water, may bypass any reactor settler tank (as it does not have high concentrations of salt to precipitate) and go straight into a membrane process as shown in FIG. 2, for example.

Thus, as opposed to the use of valves to increase concentration of monovalent species (and/or multivalent species) described above, the description shown in FIG. 7 can be an alternate embodiment (and thus an alternate method) to increasing monovalent or multivalent concentration. In yet another embodiment, those skilled in the art will recognize that one could combine valves (such as those described above) with the output monovalent and multivalent streams in FIG. 7.

In yet another alternate embodiment, one may use the sequential ED cells in such a manner that concentration in the monovalent and multivalent streams is not increased from cell to cell. In such an alternate embodiment, one could control the flow rate through the monovalent and multivalent channels in order to ensure that the increased concentration of monovalent and/or multivalent species achieved in the chambers of the first ED cell 1700, is held constant as the water progresses through the second ED cell 1700′ in sequence and subsequent ED cells 1700n in sequence.

Liquid process streams must be free of particles and high organic content, since ED is subject to membrane fouling. For this purpose, Electrodialysis Reversal (EDR) is a possible solution. EDR is operated like ED, but when fouling has built to a certain level, the setup is altered by reversing the direction of the constant current driving the separation and switching the dilution and concentration chambers. This way, it is possible to prolong the ED operation without having to stop and clean the equipment. Reversing the polarity of the electrodes is known to reverse the flow of ions and thereby allow the membrane to self-clean from any ionic deposits within the pores of the membrane. U.S. Pat. No. 3,043,768 (Jul. 10, 1962) has discussed polarity reversal in electrodialysis in more detail, and it is incorporated by reference herein in its entirety.

As described above, once separation of monovalent and multivalent species is achieved, (and once any desired concentration of either or both of the monovalent and multivalent streams has been reached), the two streams may be processed separately. For either of these streams 1100, 1120, the salts may first be precipitated from the liquid, as described briefly above in the overview of the system 1000.

Precipitation of Salt from Water

As described above, the system includes ED cells, which can separate ionic contaminants into separate streams such as a stream including monovalent ionic species and a stream including multivalent ionic species. These streams can then be directed to reactor/settler tanks 1150, 1330, respectively, where salts can be precipitated from the streams. This occurs, in one aspect, by using a solvent to precipitate any salts out of solution (i.e., out of the water), and by providing apparatus and methods for same. The solvent may be an organic solvent. To that end, ethanol precipitation is a widely used technique to purify or concentrate nucleic acids. In the presence of salt (in particular, monovalent cations such as sodium ions), ethanol efficiently precipitates nucleic acids. Nucleic acids are polar, and a polar solute is very soluble in a highly polar liquid, such as water. However, unlike salt, nucleic acids do not dissociate in water since the intramolecular forces linking nucleotides together are stronger than the intermolecular forces between the nucleic acids and water. Water forms solvation shells through dipole-dipole interactions with nucleic acids, effectively dissolving the nucleic acids in water. The Coulombic attraction force between the positively charged sodium ions and negatively charged phosphate groups in the nucleic acids is unable to overcome the strength of the dipole-dipole interactions responsible for forming the water solvation shells.

The Coulombic Force between the positively charged sodium ions and negatively charged phosphate groups depends on the dielectric constant (□) of the solution, and is given by the following equation:

$$F = \frac{{q}_{1} {q}_{2}}{4 {πɛ}_{o} {ɛ}_{r} {r}^{2}} = 8.9875 \times {10}^{9} \frac{{q}_{1} {q}_{2}}{{ɛ}_{r} {r}^{2}} newtons$$

Adding a solvent, such as ethanol to a nucleic acid solution in water lowers the dielectric constant, since ethanol has a much lower dielectric constant than water (24 vs 80, respectively). This increases the force of attraction between the sodium ions and phosphate groups in the nucleic acids, thereby allowing the sodium ions to penetrate the water solvation shells, neutralize the phosphate groups and allowing the neutral nucleic acid salts to aggregate and precipitate out of the solution [as described in Pi\check{s}kur, Jure, and Allan Rupprecht, “Aggregated DNA in ethanol solution,” FEBS Letters 375, no. 3 (November 1995): 174-8, and Eickbush, Thomas, and Evangelos N. Moudrianakis, “The compaction of DNA helices into either continuous supercoils or folded-fiber rods and toroids,” Cell 13, no. 2 (February 1978): 295-306, the disclosures of which are incorporated by reference herein in their entireties].

Thus, another aspect of the present invention contemplates that the principles regarding the precipitation of nucleic acids via the introduction of water miscible solvents can also be used to precipitate soluble salts, which, like nucleic acids, have solvation shells formed around the ions. Thus, by lowering the dielectric constant of the solution, the Coulombic attraction between the oppositely charged ions can be increased to cause the neutral salts to precipitate out of solution. This general concept has been discussed by Alfassi, Z B, L Ata. “Separation of the system NaCl—NaBr—NaI by Solventing Out from Aqueous Solution,” Separation Sci. and Technol. 18, no. 7 (1983): 593-601, incorporated by reference herein in its entirety, using data on the solubilities of several salts in a mixture of water-miscible organic solvent (MOS), wherein they found that the mass ratio (α) of the water-miscible organic solvent (MOS) to the total mass of aqueous solution (the mass of water plus the mass of solvent dissolved in the water), i.e.,

α=M_{MOS}/M_{Aqueous Solution}

can be correlated against the fraction of salt precipitated from a saturated brine solution, f, as follows:

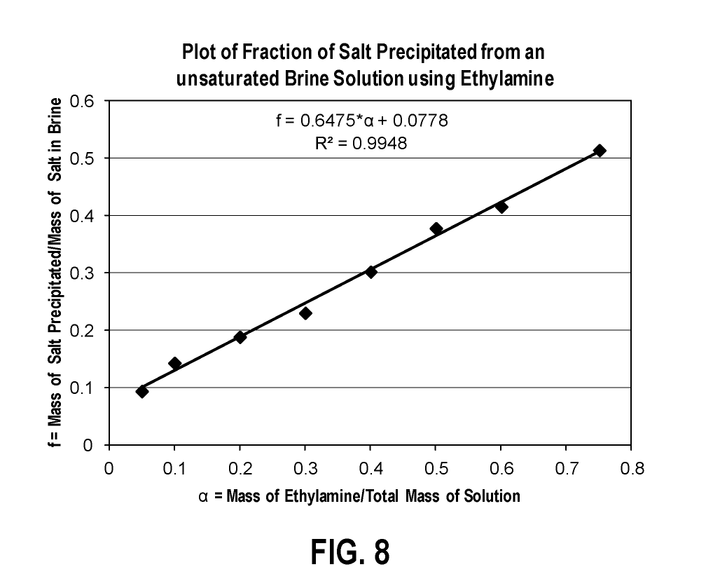

f=K*α

where K is a precipitation constant. FIG. 8 shows a plot off versus α for sodium chloride in water using ethylamine as an organic solvent. The actual amount of salt precipitated is f times the mass of salt in a saturated brine solution.

Additionally, if an organic solvent is added to an unsaturated brine solution, then salt precipitation may not begin right away, and there is a minimum amount of solvent needed to begin salt precipitation. This value of α is denoted as αₘᵢₙ, and so the equation “f=K*α” can be rewritten as follows for unsaturated salt solution:

f=αₘᵢₙ+Kα

The value of αₘᵢₙ depends on the concentration of salt in the water. Table 2 (below) shows the value of “f” as a function of □for sodium chloride precipitated from a saturated brine with addition of ethylamine.

TABLE 2
Value of “f” as a function of the α for NaCl precipitated
from a saturated brine with addition of ethylamine.

| alpha | f |
|---|---|
| 0.05 | 0.09469697 |
| 0.1 | 0.143939394 |
| 0.2 | 0.189393939 |
| 0.3 | 0.231060606 |
| 0.4 | 0.303030303 |
| 0.5 | 0.378787879 |
| 0.6 | 0.416666667 |
| 0.75 | 0.515151515 |

While ethylamine is discussed above as being the organic solvent, its use is merely an example, and there are other possible organic solvents (which will cause precipitation of the salt) that can be used instead of ethylamine. Some possible solvents include those shown in Table 3 (with the information therein obtained from CRC Handbook of Chemistry and Physics; Organic Solvents by Riddick and Bunger; and Handbook of Solvents by Scheflan and Jacobs).

TABLE 3
Partial List of Organic Solvents that may be used to
precipitate salt from water.

| | Solubility | Heat of | Specific |
|---|---|---|---|
| | in Water | Vaporization | Heat |
| Organic Solvent | (kg/L) | (cal/g) | (cal/g · deg C.) |
| Methylamine | 1.08 | 198.1 | 0.385 |
| Dimethylamine | 3.54 | 140.4 | 0.366 |
| Trimethylamine | 5.5 | 92.7 | 0.371 |
| Ethylamine | Completely | 145.7 | 0.50 |
| Acetaldehyde | Completely | 147.5 | 0.336 |
| Methylformate | 0.23 | 112.4 | 0.478 |
| Isopropylamine | Completely | 109.9 | 0.668 |
| Propylene Oxide | 0.405 | 118.3 | 0.495 |
| Dimethoxymethane | 0.244 | 90.7 | 0.507 |
| t-Butylamine | Completely | 92.8 | 0.628 |
| Propionaldehyde | 0.306 | | 0.522 |
| N-propylamine | Completely | 120.2 | 0.656 |
| Allylamine | Completely | | |
| Diethylamine | 0.449 | 97.5 | 0.577 |
| Acetone | Completely | 119.7 | 0.249 |
| s-Butylamine | Completely | 104.9 | |
| Ethanolamine | Completely | 185.5 | |
| Acetic acid | Completely | 97.1 | |
| Acetonitrile | Completely | | |
| 1,3-Butanediol | Completely | | |
| 1,4 Butanediol | Completely | | |
| Butyric acid | Completely | | |
| Diethanolamine | Completely | | |
| 2-Butoxyethanol | Completely | | |
| Diethylenetriamine | Completely | | |
| Dimethylformamide | Completely | | |
| Dimethoxyethane | Completely | | |
| 1,4-Dioxane | Completely | | |
| Ethanol | Completely | 200 | |
| Ethylene glycol | Completely | | |
| Formic acid | Completely | 115.5 | |
| Furfuryl alcohol | Completely | | |
| Glycerol | Completely | | |
| Methanol | Completely | 263.0 | |
| Methyl | Completely | | |
| diethanolamine | | | |
| 1-Propanol | Completely | | |
| 1,3-Propanediol | Completely | | |
| 1,5-Pentanediol | Completely | | |
| 2-Propanol | Completely | | |
| Propanoic acid | Completely | | |
| Propylene glycol | Completely | | |
| Pyridine | Completely | | |
| Terahydrofuran | Completely | | |
| Triethylene glycol | Completely | | |

One or more of the solvents listed above (or other suitable solvent or solvents), or a combination of solvents, may be used to precipitate salts in accordance with the principles of the present invention. To that end, the selection of the solvent is based on the following analysis: First, the organic liquid should be miscible with saturated salt water at concentrations exceeding 50 vol %. Second, the organic liquid should have a viscosity less than 90 cP, so that it can be easily pumped through the membrane system for post-precipitation separation of the solvent from the liquid (although, if other methods of separation are used to separate the solvent from water—such as evaporation of solvent—then viscosity may not be an issue). And third, the organic liquid should have a low dielectric constant, so that when mixed with salt water, it lowers the dielectric constant of the solution enough to allow the water of hydration around the salt ions to be removed, thereby allowing the ions to combine to form neutral salt. Regarding the issue of the third characteristic: Water has a dielectric constant of 80 and xylene, for example, has a dielectric constant of 2.3. When Na+ and Cl— charges cannot be insulated from each other due to lower dielectric constant, as in a water-xylene mixture, then they combine to form a salt crystal and precipitate out of solution. In one embodiment, a “low dielectric constant” may be a dielectric constant in the range of 2-20.

As described above, the precipitation of salts occurs in a reactor/settler tank (tank 1150 for the monovalent stream of water, and tank 1330 for the multivalent stream of water). Various apparatus (and configuration of apparatus) may be used for this portion of the overall process. To that end, one embodiment of the portion of the process (including apparatus) used to precipitate salts via the addition of an organic solvent to solution is shown in FIG. 2, and includes reactor/settler tanks, one tank 1150 for the stream including salts from the combined monovalent species, and one tank 1330 for the stream including salts from the combined multivalent species. In general, in this process, the saline water (from either stream 1100 or stream 1120) is mixed with a selected organic solvent, as per the discussion above. In one embodiment, this organic solvent has the following properties: (1) miscible with water; (2) boiling point higher than ambient temperature of 25° C.; (3) low heat of vaporization; and (4) does not form an azeotrope with water. In one embodiment, the ratio (α) of organic solvent added to the salt solution is in the range of 0.05 to 0.3. Additionally, the organic solvent may be non-toxic, odorless, and low cost. For example, ethylamine has a low heat of vaporization, as per Table 3, is completely miscible with water in all proportions, has a low dielectric constant and can be easily separated from water (since its boiling point is quite different than water). For example, the use of membranes to separate solvent from water will be discussed in greater detail below. When using a membrane or membranes for solvent separation, the boiling point differences between the solvent and water are not as important (as when one separates solvent using a vaporization process). Thus, if one were to use a membrane for solvent separation, one could select a larger amine molecule, such as butylamine or even a larger amine molecule, as long as it was miscible with water and had a low dielectric constant.

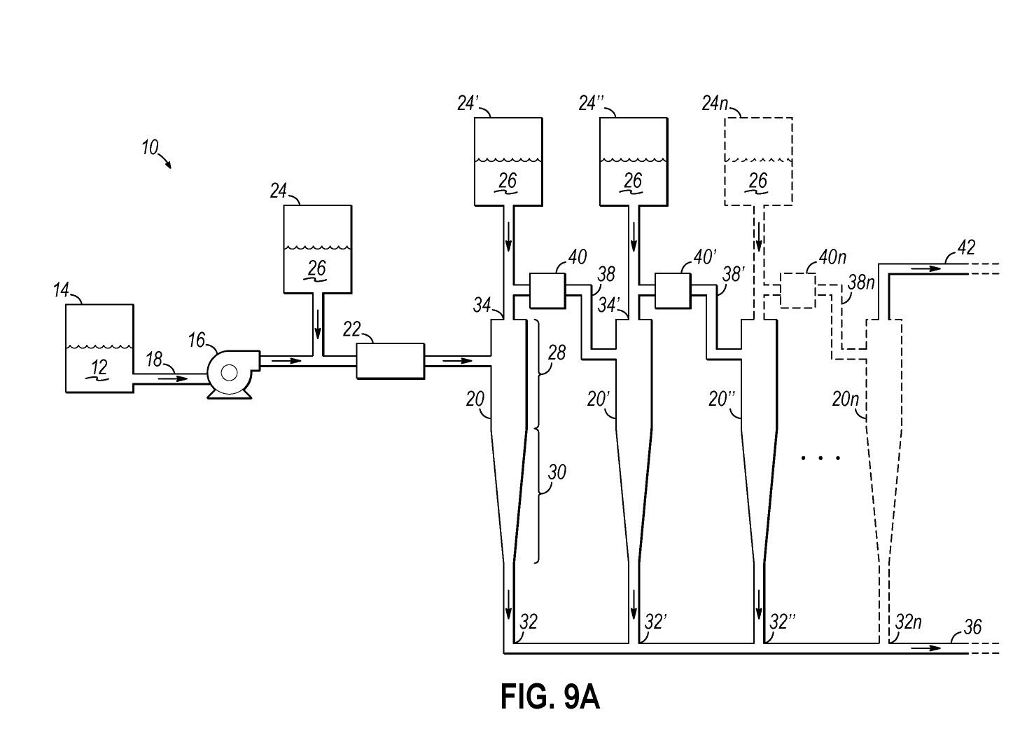

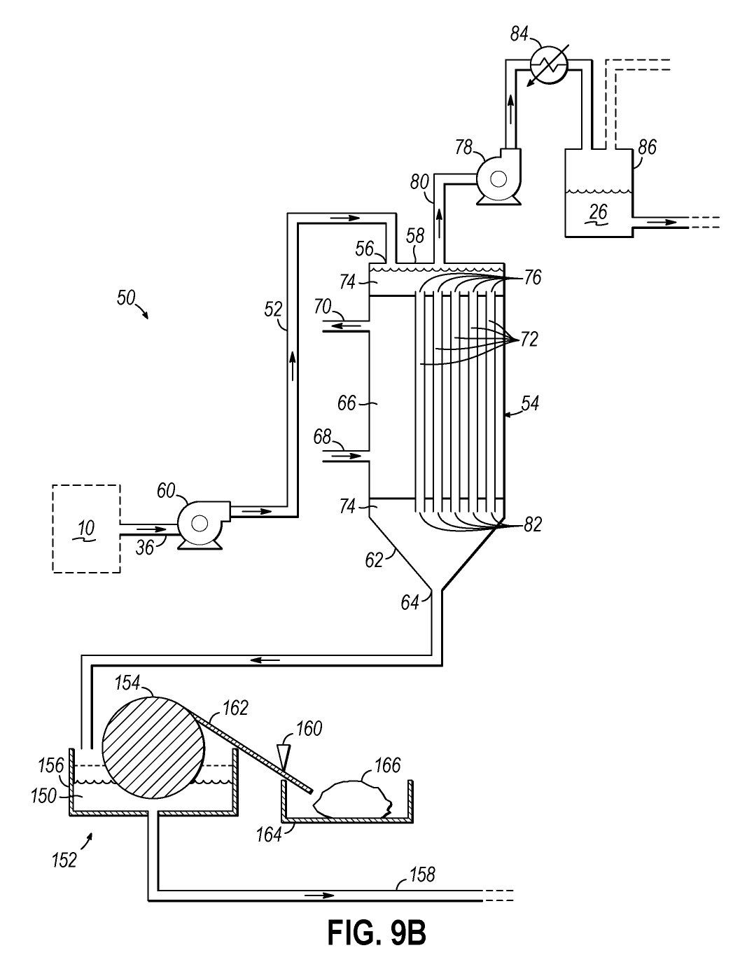

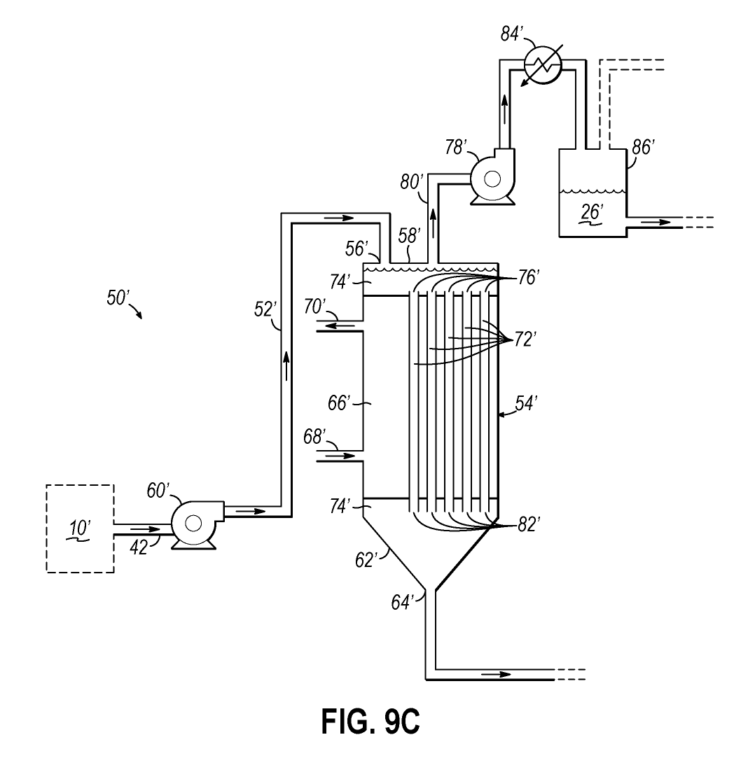

In general, once a salt solution (such as water contaminated with one or more salts), for example the stream 1100 including monovalent ions, and an organic solvent are combined, the use of the solvent will then begin to cause precipitation of salt within a reactor/settler tank (such as tank 1150 for monovalent stream). As salt begins to precipitate, it may be separated from the solution in at least one reactor/settler tank, as in the illustrated embodiment of FIG. 2. In one embodiment, the reactor/settler tank (1150 or 1330) may be a hydrocyclone. In an alternate embodiments, the system may include multiple hydrocyclones (as shown in FIG. 9A, and as will be described in greater detail below). It will be recognized by those skilled in the art that although multiple hydrocyclones are shown in FIG. 9A and may be used in series as settler tanks, one of those shown may be used as a single settler tank, such as in FIG. 2. In certain embodiments of the present invention, the entire solvent does not need to be added in one stage. Initially, the amount of solvent added results in salt precipitation, and the salt is separated from the solution using a hydrocyclone. The salt may then be removed and processed, and the water separately removed and processed (as in FIG. 2), or the overflow from this hydrocyclone may then be mixed with more organic solvent to achieve a concentration to make the salt precipitate, which is again separated using a second hydrocyclone (as in FIG. 9A). This process of incrementally adding solvent to maintain a solvent concentration for precipitation may be used to precipitate the salt from the liquid.

Apparatus Used During the Precipitation Process

Referring to FIG. 9A, a liquid 12 (such as water), having one or more inorganic salts dissolved therein, such as sodium chloride, magnesium chloride, or calcium chloride, enters from source 14 via pump 16. In describing this embodiment, which may include multiple hydrocyclones in series, those skilled in the art will recognize that such a series of hydrocyclones may be used in the system 1000 shown in FIG. 2 in place of the single reactor/settler tank 1150 and the single reactor/settler tank 1330, shown in FIG. 2. Thus, those skilled in the art will recognize that the flow path 18 shown in FIG. 9A may be equivalent to the flow path/stream 1140 shown in FIG. 2.

Path 18 connects the source 14 to at least one hydrocyclone 20. (For example, the embodiment of the system shown in FIG. 2 may be an example of the use of one hydrocyclone for the monovalent stream and one hydrocyclone for the multivalent stream—with the reactor/settler tanks 1150, 1330 shown on each side of the system 1000 being those single hydrocyclones.) Path 18 includes an in-line mixing apparatus 22, as shown in FIG. 9A, which may be used to mix water and solvent prior to entering hydrocyclone. Alternatively, any mixing of water and solvent may occur within reactor/settler tanks 1150, 1330 (as opposed to using a separate mixing apparatus). Regardless, also connected to path 18, between pump 16 and in-line mixing apparatus 22, is water miscible organic solvent source 24 including solvent 26. Thus, an initial amount of water miscible organic solvent 26, delivered from solvent source 24, is added to water 12 from source 14 in path 18, and the two components are mixed with in-line mixing apparatus 22, resulting in precipitation of some amount of the salt present in the water 12. Path 18 dispenses the mixture into hydrocyclone 20.

Hydrocyclones, in general, are devices that separate particles in a liquid suspension based on the ratio of their centripetal force to fluid resistance. Hydrocyclones generally (and as in the illustrated embodiment) have a cylindrical section 28 at the top where the slurry or suspension is fed tangentially, and a conical base 30. The angle, and hence length of the conical section, plays a role in determining operating characteristics. The hydrocyclone has two exits: a smaller exit 32 on the bottom (underflow) and a larger exit 34 at the top (overflow). The underflow is generally the denser or coarser fraction, while the overflow is the lighter or finer fraction.

Within hydrocyclone 20, a concentrated salt slurry is separated from the aqueous mixture and dispensed at exit point 32 as an underflow. The concentrated salt slurry includes at least water, precipitated salt, and water miscible solvent. The concentrated slurry has a greater amount of precipitated salt than the overflow. The underflow exiting from exit point 32 of hydrocyclone 20 is channeled via pathway 36 to be further processed. In particular this underflow may be the fluid with precipitated salt that exits settler tank as stream (1160 or 1340 in FIG. 2), to have the precipitated salt further processed for byproducts (as will be described in greater detail below) and to have any fluid including solvent returned to the settler tank (1150 or 1330 in FIG. 2).

The overflow from hydrocyclone 20 may be directed into a solvent separation part of the system 1000 (described in greater detail below) if there is only one hydrocyclone being used as settler tank 1150 or 1330. Alternatively, in a system where multiple tanks (hydro cyclones) may be used in series, overflow is directed via path 38 to a second hydrocyclone 20′. Path 38 may include an in-line mixing apparatus 40. Also connected to path 38 may be a second water miscible organic solvent source 24′. In some embodiments, source 24 may be used by being also in fluid communication with second hydrocyclone. Thus, an additional amount of water miscible organic solvent 26, delivered from solvent source 24′, is added to the overflow in path 38, and the components are mixed with in-line mixing apparatus 40, resulting in precipitation of an additional amount of the salt present in the water, and the salt is separated from the mixture in hydrocyclone apparatus 20′. A concentrated salt slurry is separated from the mixture in hydrocyclone apparatus 20′ and is dispensed at exit point 32′ as an underflow, which is combined with the underflow from exit point 32 of hydrocyclone 20 and flows via pathway 36 to be further processed, as mentioned above. Overflow from hydrocyclone 20′ may proceed via path 38′ to a third hydrocyclone 20″. Path 38′ includes in-line mixing apparatus 40′. Also connected to path 38′ is water miscible organic solvent source 24″. In some embodiments, source 24 or source 24′ may be used by being also in fluid communication with second hydrocyclone. Thus, in the illustrated embodiment, an additional amount of water miscible organic solvent 26, delivered from solvent source 24″, is added to the overflow in path 38′, and the components are mixed with in-line mixing apparatus 40′, resulting in precipitation of an additional amount of the salt present in the water, and the salt is separated from the mixture in hydrocyclone apparatus 20″. A concentrated salt slurry is separated from the mixture in hydrocyclone apparatus 20″ and is dispensed at exit point 32″ as an underflow, which is combined with the underflow from exit points 32 and 32′ of hydrocyclones 20 and 20′, respectively, and flows via pathway 36 to be further processed, as mentioned above.

In this manner, an unlimited number of hydrocyclones 20n may arranged in series in alternate embodiments of the system, wherein overflows from each of the 20n hydrocyclones proceed along each path 38n to the next hydrocyclone in the series, and in each of the paths 38n, water miscible organic solvent 26 from a source 24n delivers an aliquot of water miscible organic solvent 26 to the path 38n, resulting in precipitation of an additional amount of the salt present in the water. Mixing of the combined flows in each path 38n is accomplished by an in-line mixing apparatus 40n. Salt precipitated by the addition of water miscible organic solvent 26 from each source 24n is separated from the mixture in the corresponding hydrocyclone 20n apparatus. A concentrated salt slurry is dispensed at each exit point 32n as an underflow. The underflow from all exit points 32n of the hydrocyclones 20n is combined; the combined underflow proceeds via pathway 36 to be furthered processed. The final separation from the last of the hydrocyclones 20n in the series results in the exiting of a solution of water and water miscible solvent via path 42, which is equivalent to path 1270 or 1410 of FIG. 2 to further process the water via membranes (such as to remove the solvent, and possibly to remove any ionic species remaining in the water).

In an embodiment including the use of subsequent membrane separation of solvent, a certain amount of salt may need to be removed by the series of hydrocyclones so as to prevent fouling of the membranes. (In other words, in such an embodiment, the goal is to achieve a salt concentration which would allow a membrane process to then become technically feasible. For a membrane process to become technically feasible, the osmotic pressure difference across the membrane, in one embodiment, may be less than 1,000 psi. The osmotic pressure difference across the membrane can be calculated as follows:

$$Δ {P}_{OsmosticPress} = [ \frac{( {TDS}_{Feed} + {TDS}_{REject} )}{2} - {TDS}_{Permeate} ] * 0.01$$

where ΔP_{Osmotic Press}=Osmotic Pressure Difference in psi
TDS_{Feed}, TDS_{Reject}, TDS_{Permeate}=Total Dissolved Solids (TDS) in feed, reject and permeate flows in mg/L

Thus, it will be understood that the system of the invention may employ at least one hydrocyclone as each or either reactor/settler tank (1150, 1330), and may optionally employ more than one hydrocyclone such as two hydrocyclones, or the three or more hydrocyclones shown in FIG. 9A, or 20n hydrocyclones. How many hydrocyclones are required to carry out effective separation will depend on many factors, including the specific water solution being addressed and the desired total percent separation of salt desired. The type of salt, the amount of salt, the presence of more than one species of salt, and the presence of additional dissolved materials within the water phase of the aqueous solution, for example are relevant considerations contributing to the optimized design of the system 10.

By employing the system and the described separation methodology, a significant amount of salt is separated from the starting solution of salt in water, when the final water-water miscible solvent mixture that leaves reactor/settler tank (1150 or 1330) as overflow is compared to the original solution of inorganic salt in water. For example, in some embodiments, about 50% to 99.9% of the salt may be separated from the starting solution of inorganic salt in water, wherein the inorganic salt is separated in the form of the salt slurry. In certain embodiments, substantially all the salt is separated from the starting solution of inorganic salt in water.

Both the overflow and the underflow (as shown in FIG. 9A) will contain some organic solvent. The underflow(s) are the separated salt slurry from the aqueous mixture formed by adding the water-miscible solvent to the solution of the inorganic salt in water. The underflow(s) proceed via path (36 in FIG. 9A, or equivalent paths 1160 or 1340 in FIG. 2) to be further processed, such as to produce byproducts, which may be sold to mitigate or offset the cost of the system and operation of the same.

Production of Byproducts

As described above, one aspect of the present invention involves the idea that saleable byproducts may be obtained from the salts precipitated (to mitigate the costs of water treatment). The concept of recovering minerals from seawater has been proposed as a way of counteracting the gradual depletion of conventional mineral ores. As described above, seawater contains large amounts of dissolved ions. The four most concentrated metal ones of these (Na, Mg, Ca, K) are being commercially extracted today. However, all the other metal ions exist at much lower concentrations. The oceans contain immense amounts of dissolved ions which, in principle, could be extracted without the complex and energy intensive processes of extraction and beneficiation which are typical of land mining. In addition, an important fraction of the minerals which are lost as waste at the end of the economic process end up in the sea as dissolved ions. In this sense, the oceans could be considered an infinite repository of materials that could be used for closing the industrial cycle and attain long term sustainability.

Open ocean water contains dissolved salts in a range of 33 to 37 grams per liter, corresponding to a total mass of some 5E+16 tons, (in the “E-notation”, E+16 means 10 elevated to the power of 16). In other words, the oceans contain some fifty quadrillion tons of dissolved material. This is a huge amount compared to the total mass of minerals extracted today in the world, which is of the order of a hundred billion tons per year. However, most of the mass dissolved in the oceans is in the form of just a few ions and these are not the most important ones for industry.

The four most concentrated metal ions, Na+, Mg2+, Ca2+, and K+, are the only ones commercially extractable today, with the least concentrated of the four being potassium (K+) at 400 parts per million (ppm). One of the least concentrated of the other ions is lithium, which has a concentration of around 0.17 ppm, and has never been extracted in commercial amounts from seawater. Other dissolved metal ions exist at lower concentrations, sometimes several orders of magnitude lower. And none of those has ever been commercially extracted.

In Table 4 (below) seawater concentrations and total amounts of some metal ions have been listed. The table excludes those already being extracted (Na+, Mg2+, Ca2+, and K+) and those which exist only in traces so minute that extraction is simply unthinkable. The amounts available in seawater are compared with the reserves listed by the United States geological survey (USGS). The concept of “reserves” may be conservative but the results of a recent work (Bardi U.; Pagani, M. The Oil Drum, Peak Minerals, 15 Oct. 2007) show that it may be the

TABLE 4
Concentration of elements in sea water and in land mineral reserves.

| | Concentration in | Total oceanic | Mineral reserves |
|---|---|---|---|
| Element | seawater (ppm) | abundance (tons) | (tons) |
| Li | 0.178000 | 2.31E+011 | 4.10E+008 |
| Ba | 0.021000 | 2.73E+010 | 1.80E+008 |
| Mo | 0.010000 | 1.30E+010 | 8.60E+006 |
| Ni | 0.008800 | 8.58E+009 | 8.70E+007 |
| Zn | 0.005000 | 6.50E+009 | 1.80E+008 |
| Fe | 0.003400 | 4.42E+009 | 1.50E+011 |
| U | 0.003300 | 4.28E+009 | 2.60E+006 |
| V | 0.001800 | 2.47E+009 | 1.30E+007 |
| Ti | 0.001000 | 1.30E+009 | 7.30E+008 |
| Al | 0.001000 | 1.30E+009 | 2.60E+010 |
| Cu | 0.000900 | 1.17E+009 | 4.90E+008 |
| Mn | 0.000400 | 5.20E+008 | 4.60E+008 |
| Ca | 0.000390 | 5.07E+008 | 7.00E+009 |
| Sn | 0.000280 | 3.64E+008 | 6.10E+006 |
| Cr | 0.000200 | 2.60E+008 | 4.76E+008 |
| Cd | 0.000110 | 1.43E+008 | 4.90E+005 |
| Pb | 0.000030 | 3.90E+007 | 7.90E+007 |
| Au | 0.000011 | 1.43E+007 | 4.20E+004 |

most realistic estimate of what we can actually extract from land mines.

Bromine has been recovered from sea water by oxidizing the bromide to bromine using chlorine gas. However, in this case, substantial consumption of chlorine gas occurs due to the low bromide concentrations in sea water. By using the monovalent concentrate from the ED system, which will consist of mainly chloride, bromide, carbonate and bicarbonate salts, recovery of bromine is significantly more economical, since, as described above, the various ions can be concentrated via the use of the novel electrodialysis cells described herein.

As described above, with reference to FIG. 2, BrSO₄ is present in seawater and can be precipitated in the system 1000 and processed to make a saleable by-product: Bromine (Br₂). To that end, Br and SO4 will be separated within the ED cell, and when passing out of the streams Br— will be combined with Na+ to form NaBr in the monovalent stream, and in that stream, it will also be mixed with NaCl (due to the presence of NaCl in the stream because of the Na+ and Cl— ions that will come out of the ED cell(s)). Slurry (i.e., the water with precipitated salt) that exits the bottom of the reactor tank 1150 is pumped in a stream 1160 to a solids press/centrifuge system 1170 whereby solids are flushed and dewatered to a point where the solvents for reactor 1150 are returned through stream 1180 back to the reactor 1150 for reuse. More specifically, separation of the solid precipitates is achieved by a filter, wherein the wet precipitate is flushed several times with the liquid to wash any organic solvent out of the solid precipitate. Methods such as this to separate the solid precipitates in a solids press/centrifuge system are known, and have been used in the prior art. The solids are then directed to a screw press 1220 to be further processed.

Separately from the solids press 1170, an electrolysis cell 1190 is fed by a stream 1200 (from the original monovalent species stream 1100), which includes monovalent ions (mostly being NaCl—because, as described above, the positive Na ions and the negative Cl ions are recombined into the single stream 1100 as they exit the ED cell 1030.) A reaction then takes place that introduces NaOH to the liquid. More specifically, NaOH is formed by electrolysis of salt (NaCl) water, in which chlorine gas is liberated on the electrode, while OH⁻ remains behind in the solution, resulting in the formation of NaOH from the positive Na⁺ ions and negative OH⁻ ions (the electrolysis process is a general process know to those skilled in the art—a schematic of which is shown in FIG. 4). The freed chlorine gas (Cl₂) is directed through a stream 1210 to the screw press 1220 (the same screw press 1220 containing the solids described above) where the chlorine gas will react with those solids to form Br₂ gas:

NaBr+Cl₂→NaCl+Br₂ (gas)

The Br₂ is then condensed as a liquid for sale as a product. Other gases released in the process may be disposed of. Solids that pass through the screw press 1220 are stored in holding tank 1240 for disposal. Should salt or other solids become a sellable by-product, they will be cleaned and sold.

High pH water (e.g., including high levels of NaOH) is fed back to the inlet 1040 of electrodialysis cell 1030 via stream 1230 to increase the pH of the water in the electrodialysis cell. Increasing pH in the water to the ED system allows materials such as silicon and boron in the water to be removed. This is because one problematic issue is the buildup of boron in water exiting the ED cell (which will eventually be sent to the membranes—e.g., nanofiltration and reverse osmosis—described below). Boron is present in sea water as uncharged boric acid that typically must be removed at least at the 90% level to produce drinking water and/or agricultural water to meet the World Health Organization guideline of 0.5 ppm of boron. Since boron is uncharged, it will not be separated in the ED cell because it won't be attracted to an electrode. And so it will simply exit the ED cell 1030 in stream 1132, which proceeds directly to reverse osmosis membranes. And, because of its uncharged nature, it will cross the reverse osmosis membrane (seen at 1310) and thus would be present in the treated water exiting the system. This would be unacceptable. A similar problem is presented by silica in sea water.

However, by increasing the pH of the water in the ED cell by supplementing it with high pH water produced by electrolysis of the NaCl solution, both silicon and boron can be ionized, which in turn causes them to be separated in the ED cell. This allows the borate and silicates to be concentrated with the other ions in the ED monovalent stream. And, this allows the ions to go to the monovalent reactor/settler tank 1150 and precipitate out as a solid in the presence of the organic solvent. Methods of raising the pH of a liquid to 10-10.5 to convert uncharged boric acid to monovalent borate, and uncharged silica is converted to monovalent silicate is taught in U.S. Pat. Nos. 4,298,442, 5,250,185, and 5,925,255, incorporated by reference herein in their entireties.

Also, as mentioned above, another element that can be extracted from a flow exiting from the ED cell (e.g., a multivalent material) is magnesium, which can be easily precipitated as magnesium hydroxide using sodium hydroxide to raise the pH of the concentrate.

And so, for example, MgSO₄ is present in seawater and can be precipitated in the system 1000 and processed to make a saleable by-product: Magnesium. A process for obtaining magnesium from precipitated salts is disclosed in U.S. Pat. No. 2,405,055, incorporated by reference herein in its entirety. Referring to FIG. 2, in general, slurry (i.e., the water with precipitated salt) that exits the bottom of the reactor/settler tank 1330 is pumped in stream 1340 to a solids press/centrifuge system 1350 whereby solids are flushed and dewatered to a point where solvents for reactor 1330 are returned through stream 1360 back to the reactor tank 1330 for reuse. More specifically, separation of the solid precipitates is achieved by a filter, wherein the wet precipitate is flushed several times with the liquid to wash any organic solvent out of the solid precipitate. Methods such as this to separate the solid precipitates in a solids press/centrifuge system are known, and have been used in the prior art. The solids are then directed to a screw press 1220 to be further processed. Solids that pass through screw press 1370 are stored in holding tank 1380 for disposal. Should multivalent salts or other solids become a saleable by-product, they will be cleaned and sold.

Thus, addition of the electrodialysis cell(s) (ED stack) increases the cost of the system (via additional apparatus, and the electricity needed to perform the electrodialysis function). However, this cost can be offset because the system allows for separation of monovalents from multivalent, and thus byproducts (bromine and MgSO₄, for example) can be obtained from the waste streams to be sold to recoup the extra cost.

Solvent Separation Methods

As described above, any water (overflow or overflows) that are removed from the reactor/settler tank or tanks (e.g. hydrocyclones) of various embodiments of the system include some solvent. And so, a further aspect of the present invention involves removing the solvent from the water. The solvent may be removed via multiple methods. For example, membranes may be used to remove the solvent. Such a method may include one membrane or multiple membranes. Further, such a method may include one or more of ultrafiltration membranes, nanofiltration membranes, and reverse osmosis membranes in varying configurations.

The membranes described above may also be used to separate a precipitated salt or salts from the water, as opposed to, or in addition to, removing solvent from the water (as some salts may remain in the overflow).

Various other aspects of the invention regarding membrane separation may include (1) using the membrane systems described herein to reject solvent so that it is recaptured for reuse; and/or (2) using the solvent in solution to prevent fouling of the membrane.

Membrane Separation of Salts and Solvent

As described above, once salt is precipitated out of solution, another aspect involves removing the solvent from the water. For effective membrane separation of the organic from the water, a suitable membrane has to be used, which can reject the organic molecules and allow water (pure or salt water) to pass through.

An organic solvent that is miscible in water and changes the dielectric constant of the water solution to some extent can be used to cause salt precipitation to occur, following the principles of the present invention described above. In general, if the organic solvent has a large molecular weight then it can be separated from water using a membrane, such as an ultrafiltration membrane or nanofiltration membrane or reverse osmosis membrane. Larger molecules would be rejected by the membrane, while water would pass through the membrane. The rejected organic solvent can then be recycled back for reuse to precipitate more salt from the water (as described above with respect to FIG. 2).

As can be seen in FIG. 2, the discharge streams 1270, 1410 that are removed from the tops of both the monovalent settler tank 1150 and the divalent settler tank 1330 are directed to nanofiltration membranes 1260, 1400. (In the embodiment shown in FIG. 2, the reference numerals 1260 and 1400 are directed to the nanofiltration portion of the system, and as can be seen in the figure, each of 1260 and 1400 include two membranes. However, it will be recognized by those skilled in the art that one or three or any other number of nanofiltration membranes may be used at this location.) The nanofiltration membranes reject the solvent, which is returned to the settler tanks via streams 1280, 1420 to again assist in the salt precipitation process. The water that passes through the nanofiltration membranes (streams 1290, 1430) is then passed via stream 1300 through a reverse osmosis membrane 1310. These steps will be described in greater detail below.

In certain embodiments of the invention (not shown in FIG. 2) at least one ultrafiltration membrane may be positioned in the flow path between the top of the settler tank and the nanofiltration membrane (this may be done for both the monovalent stream and the multivalent stream). This also will be described in greater detail below.

Ultrafiltration

As mentioned, although not shown in FIG. 2, an ultrafiltration membrane may be included in the flow path between the tops of the settler tanks 1150, 1330 and the nanofiltration membranes 1260, 1400 in alternate embodiments of the system 1000. Ultrafiltration is a variety of membrane filtration in which hydrostatic pressure forces a liquid against a semipermeable membrane. Suspended solids and solutes of high molecular weight are retained, while water and low molecular weight solutes pass through the membrane. Ultrafiltration is not fundamentally different from nanofiltration except in terms of the size of the molecules it retains (i.e., ultrafiltration allows larger molecules to pass through the filter than does nanofiltration).

One objective of ultrafiltration (when used in the system) is to remove any particulates that may be present in the water while allowing all soluble species to get through the membrane. One of the main challenges in ultrafiltration is to maintain a high flux of water through the membrane, while minimizing the buildup of particulates on the membrane surface. In particular, liquid from each of the settlers is withdrawn from the top of the settler tank and pumped through an ultrafiltration membrane. The reject stream from the ultrafiltration membrane, which contains any large particles, is returned back to the settler tank 1150, 1330, and the permeate, which passes through the ultrafiltration membrane, is then pumped to and through the nanofilters 1260, 1400.

Thus, one objective of the ultrafiltration membrane in the flow path is to concentrate the precipitated particles so that they can agglomerate within the tanks 1150, 1330 and settle faster than otherwise. More specifically, as water leaves the settling tank, it contains some nucleated low mass solids. These solids are separated in the ultrafiltration membrane(s). In one embodiment, the ultrafiltration may be via a ¼″ tube ultra filter. Nucleated solids are larger than the pores in the ultra filter. Once they are rejected by the ultra filter, they are rejected back to the inlet of the settling tank. The low mass solids returned to the inlet of the settling tank provide seeding nucleation sites for crystal growth. As higher concentrations of solids are achieved in the tank from returning solids from other membrane processes, the crystals grow gaining mass and settle.

Ultrafiltration can be conducted using several membrane configurations, which includes: (1) hollow fiber membranes, (2) spiral wound membranes, (3) flat sheet membranes, and (4) tubular membranes. Hollow fiber membranes include several hundred fibers installed within a cylindrical shell such that the feed water permeates through the membrane to the inside of the fibers. The particulates stay outside the fibers, and periodically through back-flushing, and use of air and chemicals, the deposited particulates on the membrane surface are taken off the membrane surface and flushed away with the reject stream. In spiral wound membranes, flat membrane sheets are wound into a spiral, and spacers are used to separate the feed water from the permeate. Flat sheet membranes are installed as parallel sheets and have spaces to separate the feed water from the permeate. And tubular membranes, which are larger diameter tubes installed within a shell, operate much like the hollow fibers, except the tubes are longer and the number of tubes is in the tens rather in the hundreds.

Of all the membrane configurations, hollow fibers are the most compact with the highest surface area per unit volume. However, since the particulates are deposited outside the hollow fibers, and there are several hundred and even thousands of these very small diameter hollow fibers installed within a small diameter cylindrical shell, the particulates get caught within the fibers and are difficult to dislodge from the outside of the fibers. Spiral wound membranes have a very narrow space between the spirally wound flat sheets, since the spacers are thin, and this causes the spaces between the flat sheets to get clogged with particulates easily. Flat sheet membranes are easier to clean, but have a large number of gaskets, with one gasket between each sheet and the membrane modules are not compact. Of all the membrane configurations, tubular membranes are perhaps the easiest to clean any particulate deposits off the membrane surface. These various characteristics may be used by one of ordinary skill in the art to determine which membrane type to use in various embodiments of the present invention.

Previously used strategies to keep the membrane surface clean include (1) air injection, which helps in dislodging any deposits off the membrane surface without causing any harm to the membrane surface, (2) back-pulsing by forcing the permeate backwards through the membrane into the feed side, while interrupting the feed flow, to dislodge any particulates deposited on the membrane pores, and (3) chemicals, such as citric acid to loosen any deposits on the membrane surface. However, there are drawbacks to each of these methods. For example, back-pulsing and chemical cleaning requires the use of several control valves, which have to open and close in order to isolate the membrane module temporarily for cleaning, so that the cleaning chemicals or the permeate do not mix with the feed flow. To that end, a process for preventing fouling of membranes will be described later in this specification.

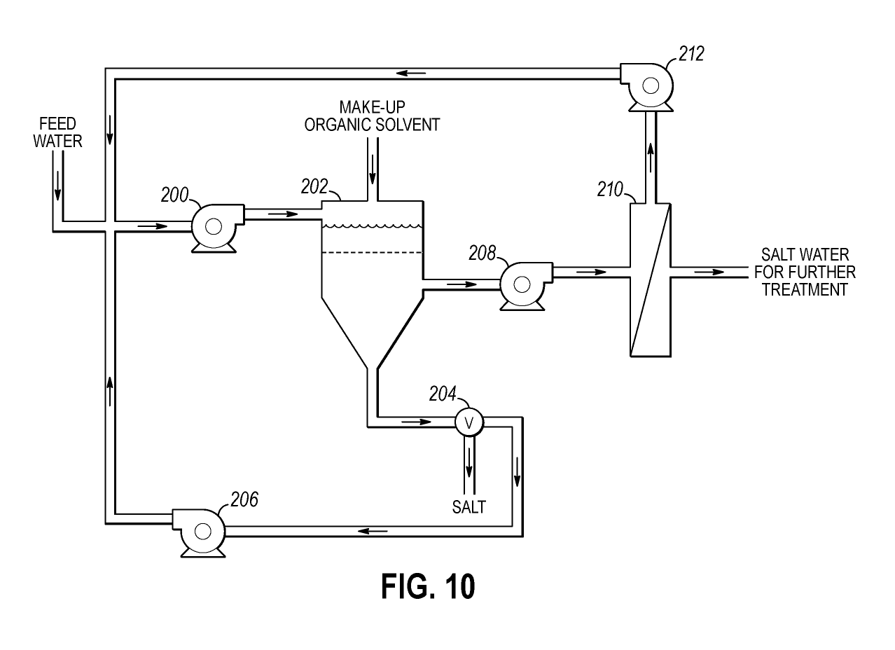

With reference to FIG. 10, the following is a description of an example of one possible embodiment of use of ultrafiltration within the system to recover solvent following salt precipitation. As described above, if the organic molecule has a high molecular weight, such as a sugar, then a simple ultrafiltration membrane can be used to recover the solvent. Feed water (such as stream including monovalent ions, or stream including multivalent ions) is pumped by the feed pump 200 into the settler tank 202, where it mixes with the organic solvent, which results in the precipitation of salts, BOD, COD, etc. (Thus, in the embodiment shown in FIG. 10, those skilled in the art will recognize that the settler tank 202 described in FIG. 10 may be equivalent to either the reactor/settler tank 1150 of FIG. 2 or the reactor/settler tank 1330 of FIG. 2.) The settled solids are taken out from the bottom of the settler and the solid slurry is sent to be further processed, not shown in FIG. 10, by a valve 204 (although a schematic and description regarding the processing of salt slurry removed from the bottom of a settler tank or tanks is shown in FIG. 2). In an alternate embodiment of the system of the present invention, some of this solid slurry may be diverted by a valve 204 into a recycle pump 206, which returns the portion of the slurry back to the inlet of the settler tank. The objective of recycling this solid slurry is that the precipitated salt crystals serve as nucleation sites for further crystal growth, and this allows the larger salt crystals to precipitate faster in the settler.

The clear liquid from the settler tank may be pumped by a pump 208 into a membrane unit, which is capable of separating the organic solvent from the salt water. If the organic solvent is a high molecular weight organic, such as sugar, then the membrane unit 210 can be an ultrafiltration membrane unit, and this would allow the organic solvent to be separated at lower operating pressures than if a nanofiltration membrane or even a reverse osmosis membrane had to be used. The salt water passes through the membrane and is further treated to remove the salt using other membrane units, such as nanofiltration and/or reverse osmosis, not shown in FIG. 10 (but as can be seen in the system illustrated in FIG. 2). The organic solvent separated by the membrane unit 210 is simply recycled back to the settler tank for reuse in precipitating further salts.

More specifically, and referring to FIG. 10, the feed water, containing salts (monovalent, divalent, etc.), enter into feed pump 200 and then flows into settler vessel 202. (Additional solvent is added to the vessel 202 also, to make up any loss of organic solvent. This make-up solvent is to make up for solvent losses when the salt slurry is sent to the filter, not shown in FIG. 10, wherein the wet salt is separated from the salt water, which is returned back to the settler.) In the settler vessel 202, some of the monovalent salts are precipitated due to the presence of solvent (in the divalent settler tank, divalent salts would be precipitated), and the resulting slurry of water and precipitated salts is removed through valve 204 to be further processed (such as shown from streams 1160 and 1340 in FIG. 2). Alternatively or additionally, some of this precipitated salt and water is recycled back to the starting point (i.e., feed point) using the recycle pump 206, where it is again directed into the settler vessel 202 via feed pump 200. The salt crystals that are present in this recycled slurry (of water and precipitated salt) assist in nucleating further salts (divalent, monovalent, etc.) from further incoming feed water, which promotes greater growth of salt crystals (upon solvent-induced precipitation from the feed water), which in turn promotes faster settling of precipitated salt in the settler, due to the increased crystal size.

The more clear portion of water from the settler 202, i.e., that portion having a lower concentration of salts (divalent, monovalent, etc.), will be located nearer to the top of the body of liquid in the tank 202, since the salt crystals will generally sink toward the bottom of the tank 202 (as described above). Thus, this more clear portion of water may be pumped by pump 208 to an ultrafiltration membrane 210 (for removal of solvent). The organic solvent is removed as it cannot pass through the membrane, and so the rejected solvent may be directed via pump 212 to be recycled back to the settler tank 202. In this manner the organic solvent is recovered and recycled back to the settler 202 to precipitate more salt from the feed water.

Thus, the solvent separated by the ultrafiltration membrane in FIG. 10 can be recycled back for reuse and the salt water that passes through the ultrafiltration membrane may then be further treated using a nanofiltration process or reverse osmosis process or combined nanofiltration/reverse osmosis process. One benefit of the above-described solvent precipitation process is to reduce the salt concentration in the water, which will further reduce the osmotic pressure needed to use nanofiltration/reverse osmosis membranes to subsequently purify the water. The reject streams from the nanofiltration/reverse osmosis membranes containing solvent, can all be recycled back to the inlet of the solvent precipitation process, to again be used to precipitate salts from incoming water (or other liquid).

Another potential application of ultrafiltration is the use of liquid membranes, which consist of either a hydrophobic or hydrophilic liquid, which is completely immiscible with either salt water or dissolved organic within the salt water. This liquid is held by capillary forces within the pores of an ultrafiltration membrane.

If this liquid membrane is hydrophilic, salt water would diffuse across the hydrophilic liquid layer, held by capillary forces within the pores of the ultrafiltration membrane, while leaving the organic behind, which due to insolubility within the liquid membrane cannot diffuse across the membrane. This allows this liquid membrane to separate the organic from salt water, even though the actual solid, porous, ultrafiltration membrane, holding the liquid membrane, has pores which are significantly bigger than the size of either the organic dissolved within the salt water and the salt water itself.

Similarly, if the liquid membrane is hydrophobic, the organic within the salt water will diffuse across the liquid membrane, while salt water would be completely rejected.

This allows the liquid membrane to separate dissolved organics from salt water. Since the rate of water transport or dissolved organic transport across the liquid membrane depends on the diffusivity of the salt water or dissolved organic within the liquid membrane, increased operating temperatures improves the flux of the salt water or dissolved organic across the membrane.

Nanofiltration

As described above, nanofiltration is also used in the treatment system 1000 illustrated in FIG. 2. Water [e.g., overflow(s)] removed from the tops of settler tanks 1150, 1330 eventually proceeds to a nanofilter 1260, 1400 regardless of whether an ultrafiltration membrane (such as that described above) is first used. The objective of nanofiltration in various aspects of the present invention is to reject solvent (remaining solvent if UF was first used), and to reject the majority of divalent soluble ionic species that have not been previously precipitated or otherwise removed from the water in the case of the divalent settler tank. In one particular embodiment, the nanofilter may be a spiral wrapped filter with a membrane spacer of 43 mil thickness. The molecular weight cut off may be in a range of 8,000 to 12,000 daltons, and in one embodiment that molecular weight cut off may be 10,000 daltons.

As described above, the nanofiltration process may be used to remove some or all of the multivalent soluble salts that have not been previously precipitated and/or otherwise removed in the multivalent settler tank (in addition to being used to reject solvent). And so, to accomplish this, in nanofiltration, the feed pressure has to exceed the osmotic pressure of all the soluble multivalent salts in the water being subjected to nanofiltration.

To that end, and as is known to those of ordinary skill in the art, the osmotic pressure, Pₒₛₘ, of a solution can be determined experimentally by measuring the concentration of dissolved salts in solution via the equation, Pₒₛₘ=1.19 (T+273)*Σ(mi), where Pₒₛₘ is osmotic pressure (in psi), T is the temperature (in ° C.), and Σ(mi) is the sum of molar concentration of all constituents in a solution. An approximation for Pₒₛₘ may be made by assuming that 1000 ppm of Total Dissolved Solids (TDS) equals about 11 psi (0.76 bar) of osmotic pressure. This approximation comes from the Van't Hoff equation, which is well known to those of ordinary skill in the art: Pₒₛₘ (atm)=iMRT, where Pₒₛₘ is in atm, M is the concentration of salt in gmoles/L, R=0.08205746 atm.L.K⁻¹.mol⁻¹, T is the temperature in degrees Kelvin, and i is the dimensionless Van't Hoff factor; 1.19 is the product of R and 14.7, which converts atm into psi, and 155 is the approximate average molecular weight of the divalent and monovalent salts; Each mole of salt yields about 2 ions, and hence the sum of molar concentrations is the sum of the concentration of the positive and negative ions from the salt. The Van't Hoff factor for NaCl is 2.

As is known to those of ordinary skill in the art, the flow of water across a membrane (Qw) depends on the difference between the feed pressure and the osmotic pressure, Pₒₛₘ:

Qw=(AP−APₒₛₘ)*Kw*S/d

where Qw is the rate of water flow through the membrane, AP is the hydraulic pressure differential across the membrane, APₒₛₘ is the osmotic pressure differential across the membrane, Kw is the membrane permeability coefficient for water, S is the membrane area, and d is the membrane thickness. This equation is often simplified to:

Qw=A*(NDP)

where A represents a unique constant for each membrane material type, and NDP is the net driving pressure or net driving force for the mass transfer of water across the membrane. The constant “A” is derived from experimental data, and manufacturers supply the “A” value for their membranes.

As with ultrafiltration (or any other membrane process), it is important to keep the membrane surface clean (i.e., prevent membrane fouling) so that efficient separation can be achieved (while minimizing or eliminating downtime of a system due to membrane cleaning or replacement). Methods to combat fouling of nanofiltration membranes are: (1) air bubbles, which disturb the deposition layer of the salts on the membrane surface; (2) use of antifouling chemicals, which keep these salts in a dissolved state, even when they achieve high concentrations at the membrane surface; (3) back flow, by temporarily decreasing the feed pressure, which causes reverse flow through the membranes, and (4) low pH, i.e., acid conditions, since most salts have a high solubility at low pH. For example, in one embodiment of the present invention, both air injection and back flow may be used, by decreasing the feed pressure below the osmotic pressure of the salts, thereby causing reverse flow through the membranes.

For example, in one embodiment of such a process, one may drop the pressure in the system while liquid is still flowing through the membrane. The pressure may then be caused to drop below osmotic pressure. When this occurs, the osmotic pressure forces a backwards flow through the membrane because the higher concentration water is on the feed side of the membrane. The backwards flow caused by the osmotic pressure consists of low TDS water and dissolves any solids that may have started to precipitate in the membrane.

Further, since water is flowing backwards, some solids and high concentration water flow from the membrane into the feed side of the membrane. These are carried away in the reject stream as pumping of liquid through the entire system is ongoing. In other words, pressure is decreased on the feed side of the membrane below the osmotic pressure, so that water flows backwards from the permeate to the feed side of the membrane. In one embodiment, a reject valve may be opened to allow inlet water to flow through the membrane and out into the reject stream. The pressure in the feed side of the membrane decreases to less than that of the osmotic pressure across the membrane. The water all passes along the membrane surface but does not permeate the membrane due to osmotic pressure. Since the pressure on the feed side is less than the osmotic pressure across the membrane, water flows from the permeate side to the feed side where it joins the flow on the feed side and exits through the reject pressure control valve.

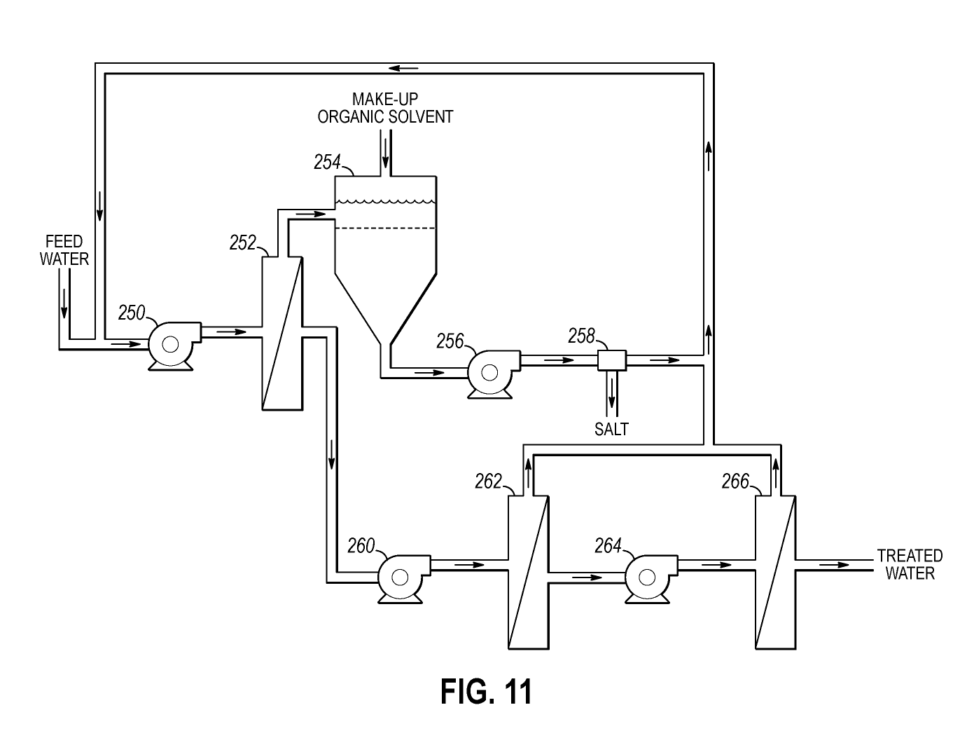

Thus, another possible implementation of the solvent precipitation process is to use an organic solvent that can be recovered using a nanofiltration/reverse osmosis membrane system. As shown in FIG. 11, the solvent can be recycled back, and the reduced concentration of salt in water can be further treated using nanofiltration/reverse osmosis process. (FIG. 11, then, shows a process that can be used within the overall system described herein, and may be used in place of, or to supplement, portions of the system, such as the embodiment shown in FIG. 2.) In this case, the nanofiltration/reverse osmosis membranes used to reject the solvent mainly have a higher molecular weight cutoff than the membranes that are used subsequently in treating the water.

Another possible implementation of the solvent precipitation process, shown in FIG. 11, is using an organic solvent that passes through the nanofiltration membrane, but the nanofiltration membrane is capable of rejecting some salt, and this means that the reject stream from the nanofiltration membrane will have a higher concentration of salt than the feed stream. This reject stream can then be put into the solvent precipitation process, precipitating salt that can be filtered out. The amount of organic solvent need to achieve a specific lower concentration of salt depends on the inlet salt concentration, as given by equation given earlier in this application, namely, f=αₘᵢₙ+Kα where α is the mass fraction of solvent needed for precipitation, and f is the fraction of salt that is precipitated. For a salt saturated solution, αₘᵢₙ is =0. However, for an under-saturated salt solution, αₘᵢₙ is finite, and increases as the salt solution gets more and more under-saturated. Hence, if the feed water is under-saturated, then a nanofiltration membrane is used, as shown in FIG. 11, to concentrate the feed to a higher salt concentration, and hence the reject stream entering the settler, has a higher salt concentration, and hence will need lesser solvent to achieve a lower salt concentration. The salt slurry precipitated in the settler is removed from the bottom of the settler and is partly sent to a filter, not shown in FIG. 11, and partly recycled back to the settler feed by pump.

More specifically, and referring to FIG. 11, the feed water enters into feed pump 250 and then flows into a first nanofiltration membrane 252. As described above, the separation performed by the nanofiltration membrane will cause the salt concentration of the reject stream to be increased, and this reject stream is then sent into a settler vessel 254. Additional solvent (make-up solvent) is added to the vessel 254 also, to make up any loss of organic solvent. In the settler vessel 254, salts are precipitated (due to the presence of solvent), and the resulting slurry of water and precipitated salts is removed via pump 256 and sent through filter 258 to remove salt. The liquid (water) that passes through this filter 258 is then recycled back to be combined with additional feed water and be processed through first nanofiltration membrane 252.

The permeate stream that passes through first nanofiltration membrane 252 is then directed via pump 260 to a second nanofiltration membrane 262. The reject stream from this second nanofiltration membrane is recycled back to be combined with feed water and begin the process again by passing through first nanofiltration membrane 252. The permeate stream that passes through second nanofiltration membrane 262 is then directed via pump 264 to a reverse osmosis membrane 266. The reject stream from this reverse osmosis membrane 266 is recycled back to be combined with feed water and begin the process again by passing through first nanofiltration membrane 252. The embodiment thus described and shown in FIG. 11 includes more than one NF membrane in sequence, and so is an alternate embodiment to that shown in FIG. 2 (which shows two NF membranes for each of the monovalent and multivalent streams, but those membranes are not sequential). The permeate stream passes through the reverse osmosis membrane as treated water. (Again, it will be recognized that the nanofiltration membranes described with respect to the embodiment shown in FIG. 11, may be considered to be at same location as the nanofilters shown in the system 1000 of FIG. 2.)

The organic/water solution from the settler unit is pumped through a second nanofiltration system that rejects more salt and some organic, and finally the permeate from this nanofiltration membrane is fed into a reverse osmosis membrane that rejects the remaining salt and the remaining solvent. All the reject streams are recycled back, while the permeate stream from the reverse osmosis system is the treated, desalinated water. Since the required pressure difference across the nanofiltration membrane is based on the salt concentration in the feed and in the permeate, by allowing salt water to pass through with some salt rejection in the nanofiltration membranes, any pumps only have to generate the difference between the osmotic pressures of the feed and permeate streams. The following equation gives the net driving pressure across a nanofiltration membrane:

$$NDP = [ ( \frac{{P}_{f} + {P}_{c}}{2} ) - ( {P}_{p} ) ] - [ \{ ( \frac{{TDS}_{f} + {TDS}_{c}}{2} ) - {TDS}_{P} \} \cdot 0.01 \frac{psi}{mg \text{/} L} ]$$

where

NDP=net driving pressure (psi)

P_{f}=feed pressure (psi)

P_{c}=concentrate pressure (psi)

Pₚ=filtrate pressure (i.e., backpressure (psi)

TDS_{f}=feed TDS concentration (mg/L)

TDS_{c}=concentrate TDS concentration (mg/L)

TDSₚ=filtrate TDS concentration (mg/L)

Thus, during the nanofilter portion of the system, a combination of solvent, multivalent salts, and water is subjected to the nanofilter membrane on the “multivalent” side of the system. Solvent is rejected to a greater extent than that of the water and multivalent salts. This means that the reject stream of the membrane increases in solvent concentration. This also means that the solvent concentration in the membrane pores decreases in concentration.

No water can enter the membrane pores that is not undersaturated. As an example of this, consider the following: Assume saturation of a multivalent salt is 100,000 mg/L. And assume concentration of solvent in solution reduces the concentration of the multivalent salt to 75,000 mg/L. In the pores of the membrane, some of the multivalent salt has been rejected. And a greater percentage of the solvent has been rejected. So, what is present is a solution that is unsaturated caused by both: (1) removal of solvent, which causes water to have the capacity to hold more salt, and (2) removal of salt, which causes water to have the capacity to hold more salt.

Reverse Osmosis

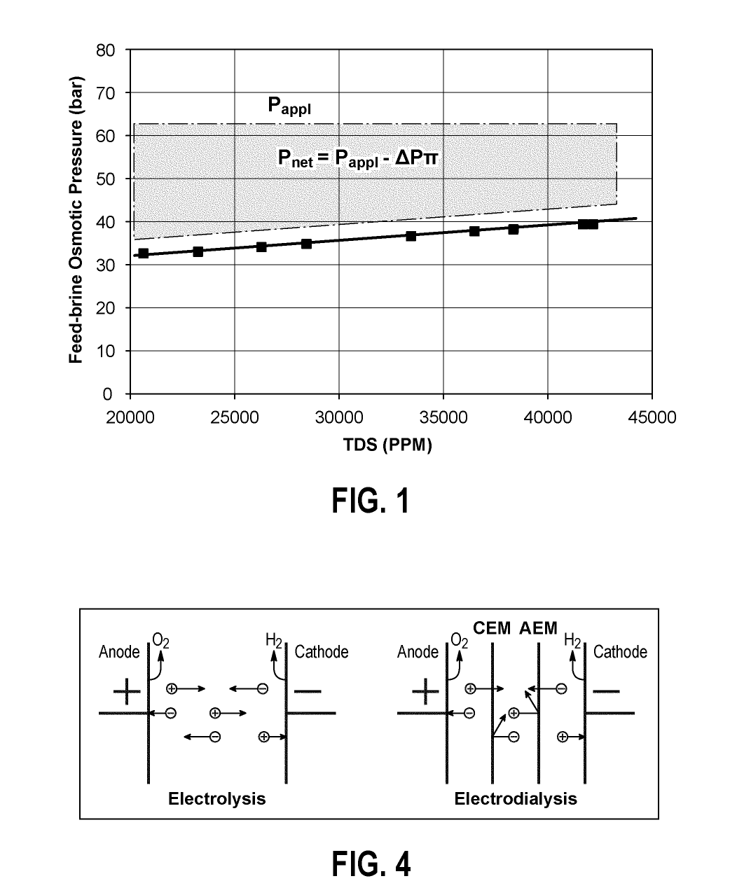

Once the streams from both the monovalent and multivalent settler tanks 1150, 1330 have passed through NF membranes 1260, 1400, treated water may then proceed via stream 1300 to reverse osmosis membrane 1310 (as described above). Reverse osmosis is a water purification technology that uses a semipermeable membrane. This membrane-technology is not technically a filtration method. In reverse osmosis, an applied pressure is used to overcome osmotic pressure, a colligative property, that is driven by chemical potential, a thermodynamic parameter (the general principles of this were described above, with respect to FIG. 1). Reverse osmosis can remove many types of molecules and ions from solutions and is used in both industrial processes and in producing potable water. Reverse Osmosis (RO), rejects all divalent and monovalent salts, as well as other contaminants, present in water (the reverse osmosis membrane is used to reject the remainder of the solvent, to reject traces of divalent salts, and to reject the remainder of the monovalent salts). The result is that the solute is retained on the pressurized side of the membrane and the pure solvent is allowed to pass to the other side. To be “selective,” this membrane should not allow large molecules or ions through the pores (holes), but should allow smaller components of the solution (such as the solvent) to pass freely.

In a normal osmosis process, solvent naturally moves from an area of low solute concentration, through a membrane, to an area of high solute concentration. The movement of a pure solvent is driven to reduce the free energy of the system by equalizing solute concentrations on each side of a membrane, generating osmotic pressure. Reverse osmosis is achieved by applying an external pressure to reverse the natural flow of pure solvent.

Reverse osmosis may be used sequentially after the nanofiltration process and one objective is to reject remaining solvent and any monovalent ionic species in the water. These ionic species include salts of sodium, ammonium, and potassium, for example.

Just like in nanofiltration, the osmotic pressure of the monovalent ions has to be overcome to allow water to flow through the membrane. Fouling of the membrane is combated by using all or some of the strategies used for nanofiltration. By reducing the concentration of the monovalent ions, the osmotic pressure that needs to be overcome during reverse osmosis has also been decreased substantially. This reduces power consumption, the fouling tendency of the membrane and the life of the membrane itself.

One will also have to allow for handling of contaminants that build up in the plant that do not precipitate. Products that do not precipitate will be of two classes: (1) products such as alkanes (e.g., hexane), and (2) products such as biocides. More specifically, products such as alkanes (hexane) will build up until they float on top of the water in the settling tank and form a layer. A mechanism can be put in place to recognize the presence of the layer and it can be decanted via port on the side of the vessel. And, products such as biocides will build up in concentration and pass through all filter except the reverse osmosis membrane. A maximum concentration will be decided upon and the reverse osmosis reject stream will be “blown down” when concentration reach the targeted maximum. The reverse osmosis reject stream contains the biocides and has the least concentration of solvent. This makes it the target for the blow down point. If large amounts of biocides are delivered and blow down requirements grow, one may add a small tight membrane to separate the solvent from the biocide.

Prevention of Membrane Fouling

As described above, fouling of membranes in water treatment processes is a substantial problem of the prior art. In the system of the present invention, there are multiple membranes (e.g., the membranes used in the electrodialysis cell(s), any nanofilter membranes, and any reverse osmosis membranes). Thus, there are multiple points in the system 1000 that could be disrupted by membrane fouling. Other aspects of the present invention, however, are related to the concept of preventing fouling of a membrane or membranes within the system.

Turning first to the membranes present within the ED cell(s) (e.g., nanofilter membranes): As described in the background section, gypsum (calcium sulfate) is a problematic compound that fouls membranes of the prior art, creating a problem which the prior art has not solved. The novel ED cell(s) of aspects of the present invention reduce and eliminate this issue. This is because in the electrodialysis used in the prior art, standard ion exchange membranes are used to concentrate neutral salts. Because of this, calcium sulfate is allowed to form, and be concentrated. This presence of concentrated calcium sulfate within the water in the ED cell(s) of the prior art leads to fouling/clogging of the membranes.

The ED cell(s) of the present invention, however (and as described above), do not use the typical ion exchange membranes of the prior art. Rather, the present ED cell(s) include a membrane or membranes that allow passage therethrough of monovalent ions, but substantially prevents the passage therethrough of multivalent ions (e.g., a nanofilter membrane). Thus, as described in greater detail above, the present ED cell(s) keep negative and positive multivalent ions separate from each other. This eliminates the formation of neutral calcium sulfate, because the Ca⁺⁺ ion is separated from the SO₄⁻⁻ ion (for example, see FIG. 6). With the presence of calcium sulfate being eliminated, due to the structure of the ED cell, the fouling of the ED membranes that is prevalent in the prior art is eliminated.

Turning now to the other membranes that may be present in the system 1000: One effect of the solvent precipitation process is that the nanofiltration membrane(s) and even the reverse osmosis membrane(s) will undergo less fouling due to salt deposition when an organic solvent is present in the feed. To fully understand this effect of solvent, one can look to what causes a membrane that is being used for desalination to foul.

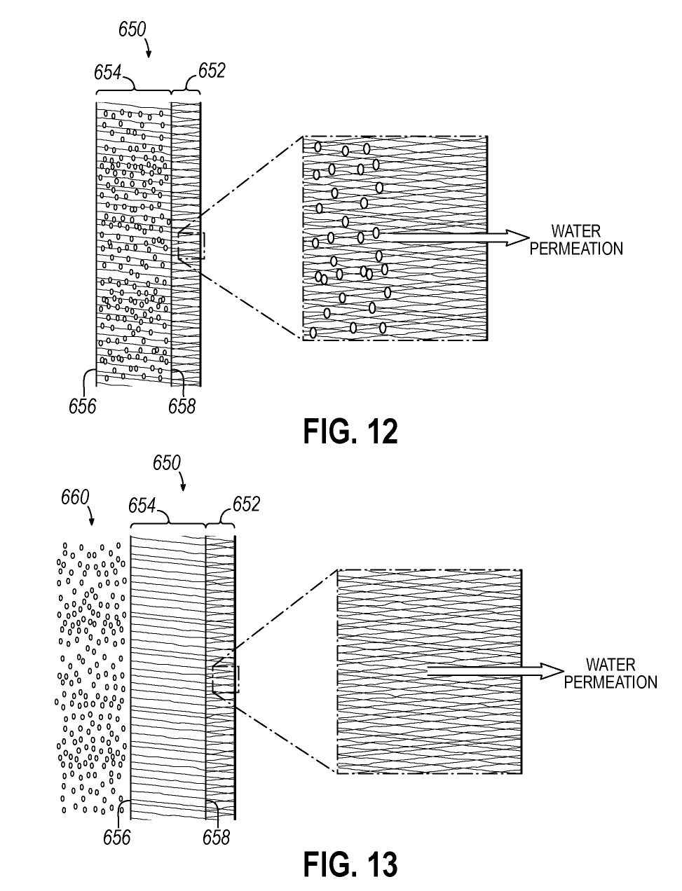

Reverse osmosis membranes have an asymmetrical structure with large pores on one side of the membrane, which decrease in size as you traverse the thickness of the membrane, with a dense layer on the opposite side of the membrane. Membrane fouling occurs due to salt deposition on the membrane surface, which can be periodically cleaned, and also within the membrane structure. This salt deposition occurs due to selective permeation of water through the membrane, and is mainly caused by salt supersaturation, as water moves through the membrane to the permeate side. This is schematically shown in FIG. 12. Salt deposition within the membrane results in irreversible loss of membrane water permeability over time, eventually requiring membrane replacement.

With the presence of the solvent in the feed water, as in the case of the solvent crystallization process, as water selectively permeates through the membrane, the organic solvent concentration increases, and this results in salt crystallization occurring outside the membrane, as shown in FIG. 13. These fine salt crystals continue to flow with the feed water, eventually leaving the membrane module as the reject stream. The main point here is that before the salt can deposit inside the membrane, it crystallizes outside the membrane, thereby preventing the occurrence of supersaturation condition within the membrane structure, which results in salt deposition within the membrane, as in the case of normal operation of the membrane without an organic solvent.

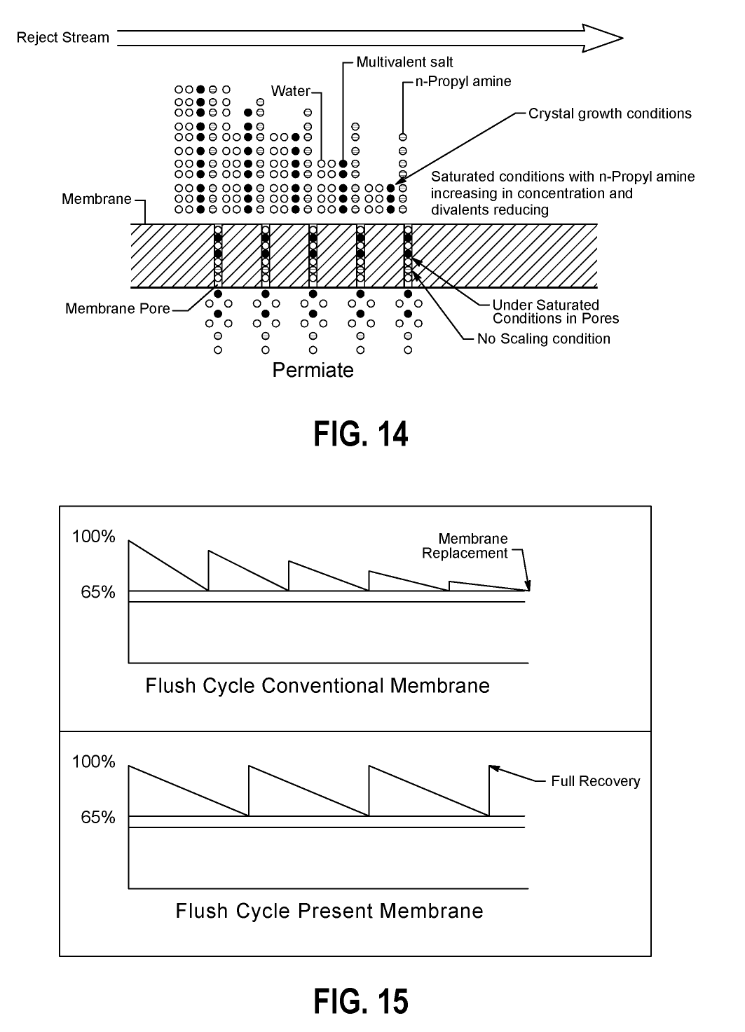

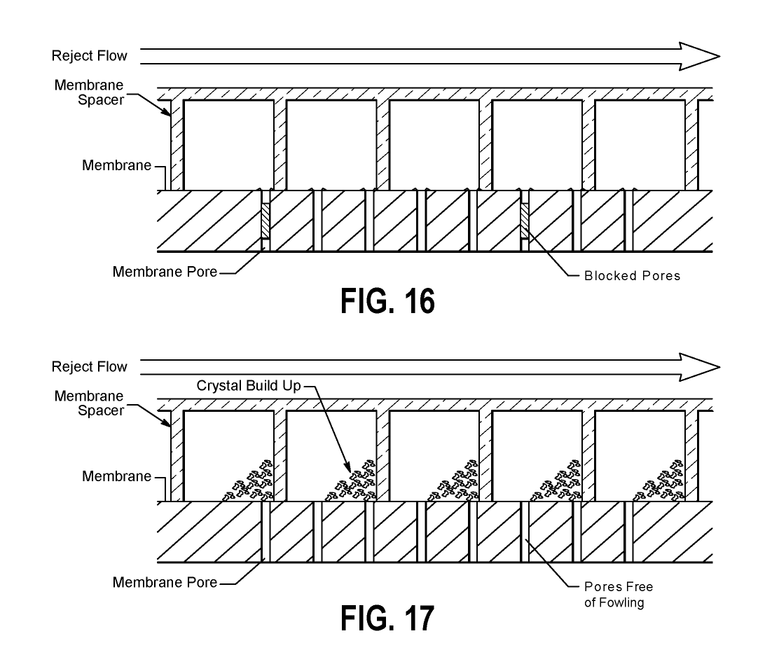

FIG. 14 shows the impact of the organic solvent on the fouling of the membrane due to salt deposition. The presence of the organic solvent on the feed side of the membrane and its presence within the membrane pores actually assists in keeping the salt in solution by forming an under-saturated solution within the membrane. In conventional membranes, the fouling of the membrane due to the deposition of the soluble species on the surface and within the membrane results in a gradual decrease in membrane permeability, as shown in FIG. 15, wherein after each backflush cycle, the membrane water permeability increases but to the same extent as was present before the fouling began, and this gradual decline in permeability limits the number of backflush cycles before the membrane has to be replaced. FIG. 16 shows one of the membrane fouling mechanism, wherein the membrane pores get blocked with precipitated solids, while FIG. 17 shows the mechanism of solids deposition on the membrane surface, which causes decline in membrane permeability.

Non-Membrane Separation of Solvent

The various embodiments of the system described above use one or more membranes following precipitation of salts (whether from a monovalent stream or a multivalent stream) in order to remove solvent (and some remaining salt) from the liquid (water) being treated. Apart from the membrane processes described above, alternate embodiments of the system may use other methods of separation of solvent. In particular, certain alternate embodiments may use vaporization processes to separate the organic solvent from the water (these processes may be used in place of membrane processes, or may be used in addition to membrane processes). In such embodiments, in order to minimize the energy for removal of solvent after separation, the use of low-boiling temperature organic solvents is recommended. The energy required to evaporate saturated brine to recover salt is 1505.5 Cal/gm of salt recovered. For ethylamine, however, the amount of energy required to heat brine and ethylamine to the boiling point using an a value of 0.75, (i.e., 75 g of ethylamine for 100 g of saturated brine with 26.4 g of sodium chloride in solution), is 803.5 cal/g of salt precipitated. Hence, the energy ratio of the energy required to vaporize ethylamine per unit weight of salt precipitated to the energy required to vaporize water from brine per unit weight of salt precipitated is 0.53 (803.5/1505.5=0.53). Hence, the energy consumption to obtain salt using the method of the present invention using ethylamine is about half the energy that would have been expended in evaporating water from brine (one of the prior art methods).

Table 5 (below) gives the ratio of the energy needed to evaporate ethylamine to the energy required to evaporate the water. Note that this calculation is approximate since it neglects the sensible heat effects of heating the brine to its boiling point and the sensible heat required to heat the solvent mixture to the boiling point of the solvent. It is estimated that these sensible heat effects will be small compared to the heats of vaporization of the water and solvent. Of course, if a non-vaporization method (e.g., membranes) is being used to separate the organic solvent from the water, then the energy ratio calculated in Table 5 is no longer applicable, since the energy ratio assumed that the solvent was going to be evaporated.

TABLE 5
Ratio of Energy required to evaporate the
Solvent, Ethylamine and the Energy
required to evaporate water from the brine solution.

| alpha | Energy Ratio |
|---|---|
| 0.05 | 0.19 |
| 0.1 | 0.25 |
| 0.2 | 0.39 |
| 0.3 | 0.48 |
| 0.4 | 0.48 |
| 0.5 | 0.48 |
| 0.6 | 0.53 |
| 0.75 | 0.53 |

As noted above, alpha (α) is the ratio of the mass of solvent (in this case, ethylamine) added to the total mass of solution. The energy ratio is minimized when the amount of solvent added is the least, as shown in the table. In other words, the less organic solvent used, i.e., lower the value of alpha, the amount of energy used to evaporate this solvent will also be less, as shown in Table 5.

As described previously, both the overflow and underflow from the reactor/settler tanks (e.g., hydrocyclones) of the illustrated embodiment of FIGS. 2 and 9A will include solvent (the underflow will also include a larger amount of precipitated salt). In an alternate embodiment, instead of using the membrane systems shown in FIG. 2 and described above, in their place the underflow (whether from one hydrocyclone or multiple hydrocyclones) may be pumped into a degassing system (seen in FIG. 9B) in this alternate embodiment, and the overflow (whether from one hydrocyclone, or from the final hydrocyclone of a series) may be pumped into a degassing system (seen in FIG. 9C) in this alternate embodiment. (Still alternatively, the degassing system may be used in addition to membranes for separation of solvent.) In this application, when referencing multiple hydrocyclones, tubes, etc., it will be recognized that a single hydrocyclone, tube, etc. may be substituted—the number is not limiting. The apparatus of vessel for underflow and vessel for overflow may be of similar construction (as both are used for separation of solvent). Both the system of FIG. 9B and the system of FIG. 9C may use separator apparatus to remove solvent from underflow and overflow. The separator may include, in one embodiment, a wetted wall tube (such as a wetted wall static separator tube). Further, the separator may be structured to include (a) a housing having at least one wall defining an interior space, an open top end, and an open bottom end, wherein the at least one wall has an inner surface and an outer surface; and (b) a contour disposed on or defined by at least a portion of the inner surface of the at least one wall; and (2) wherein a flow path for an aqueous mixture is provided by at least a portion of the contour and the inner surface of the at least one wall. And, in embodiments where the separator is a wetted wall tube, the tube may include the contour described above.

Underflow

More specifically, and referring to FIG. 9B, a system 50 is shown that includes apparatus suitable for carrying out methods of various aspects of the invention for removal of solvent from underflow. In the embodiment shown in FIG. 9B, system 50 enables the evaporation of the water miscible organic solvent 26 from the slurry, and further enables the optional separation of precipitated salt from the water, wherein one optional means for separating the precipitated salt from the water is shown in FIG. 9B. Underflow from path 36 of FIG. 9A is directed via path 52 of FIG. 9B to the top of evaporation vessel 54, via opening 56 of the enclosed top chamber 58 of vessel 54, aided by pump 60. Vessel 54 includes inlet 56 for the underflow, that is, the incoming salt slurry; top chamber 58; bottom chamber 62; outlet 64 for the concentrated salt slurry; optional jacketed area 66 with inlet 68 and outlet 70 for jacketed temperature control via addition of a heated fluid; and wetted wall separators 72 situated substantially vertically and disposed at least partially within top chamber 58 and bottom chamber 62.

Salt slurry, that is, the underflow 74 in path 36 from a separation system 10 such as that shown in FIG. 9A enters top chamber 58 by flowing along flow path 52 through inlet 56. When the level of underflow 74 in top chamber 58 reaches the level of the top openings 76 of the wetted wall separation tubes 72, it enters and flows down the hollow tubes 72, aided by gravity. As the liquid 74 proceeds down tubes 72, a lower pressure is applied at the top of the tubes 72 by applying a vacuum 78 along path 80 leading from the top chamber 58 of vessel 54. Optionally, instead of applying a vacuum, the lower pressure is applied in some embodiments by forcing an air flow from the bottom openings 82 of tubes 72, disposed within bottom chamber 62 of vessel 54, toward the top openings 76, such as by a blower (not shown). Application of lowered pressure aids in the evaporation of the water miscible solvent from the slurry, and the organic solvent is condensed and collected via path 80 and condensed via condenser 84, and the condensed water miscible solvent 26 is stored in storage tank 86. In some embodiments, this organic solvent is recycled back to the one or more sources such as sources 24n depicted in FIG. 9A, for reuse in a subsequent separation.

Within the vessel 54, the tubes 72 have openings 76 that project into top chamber 58 and openings 82 that project into bottom chamber 62. Between top chamber 58 and bottom chamber 62 of vessel 54, an optional jacketed area 66 surrounds tubes 72; the optional jacketed area 66 has inlet 68 and outlet 70. In some embodiments, a heated fluid is pumped into inlet 68, for example, by a liquid pump or heated gas pump (not shown) and exits via outlet 70. As evaporation occurs within tubes 72, loss of heat of evaporation is mitigated by adding heat to the jacketed area 66.

In some embodiments, the wetted wall separation tubes achieve evaporation of the water-miscible solvent from the salt slurry while maintaining substantial separation of the precipitated salt, that is, preventing subsequent redissolution of the salt in the water as the water miscible solvent is evaporated. This is achieved by a contour feature of the tubes as well as the inner diameter thereof. In embodiments, the wetted wall separator tubes of the invention are characterized primarily by inner diameter defining the inner wall, and height of the tube in combination with the contour feature defining at least a portion of the inner wall.

The rate of evaporation of the water miscible solvent from the salt slurry is determined by both the wetted wall separation tube itself and by additional factors. The tube properties affecting evaporation include the height of the tube, the contour dimensions of the inner wall of the tubes and the portion of the inner wall having the contour feature thereon, and the heat transfer properties of the tube—that is, tube material properties, thickness of the tube, and presence of heat transfer features present on the outer surface of the tube. Additional factors include the heat of vaporization of the water miscible solvent, external temperature control, such as by a jacketed area 66 shown in FIG. 9B, and the amount of pressure differential within the hollow separator tube between the top and bottom of the tube length. The height of the tubes useful in the evaporation is not particularly limited, and will be selected based on the amount of water miscible solvent entrained in the slurry and the heat of evaporation of the water miscible solvent. In some embodiments, the height of the wetted wall separator tubes useful in conjunction with the separation of water miscible solvent from a slurry of sodium chloride in water, using ethylamine as the water miscible solvent, is about 50 cm to 5 meters, or about 100 cm to 3 meters. In embodiments, the portion of the total length of the tube that includes the helical threaded features present on the inner wall thereof is between about 50% and 100% of the total inner wall surface area, or about 90% to 99.9% of the total wall surface area, or about 95% to 99.5% of the total inner wall surface area.

Overflow

More specifically, and referring to FIG. 9C, a system 50′ is shown that includes apparatus suitable for carrying out methods of various aspects of the invention for removal of solvent from overflow. In the embodiment shown in FIG. 9C, system 50′ enables the evaporation of the water miscible organic solvent 26 from the overflow, (and further enables the optional separation of any precipitated salt that may be in the overflow, wherein one optional means for separating the precipitated salt from the water is shown in FIG. 9C). Overflow from path 42 of FIG. 9A is directed via path 52′ of FIG. 9C to the top of evaporation vessel 54′, via opening 56′ of the enclosed top chamber 58′ of vessel 54′, aided by pump 60′. Vessel 54′ includes inlet 56′ for the underflow, that is, the incoming salt slurry; top chamber 58; bottom chamber 62; outlet 64′ for the concentrated salt slurry; optional jacketed area 66 with inlet 68′ and outlet 70′ for jacketed temperature control via addition of a heated fluid; and wetted wall separators 72′ situated substantially vertically and disposed at least partially within top chamber 58′ and bottom chamber 62′.

Salt slurry, that is, the overflow in path 42 from a separation system 10 such as that shown in FIG. 9A enters top chamber 58′ by flowing along flow path 52′ through inlet 56′. When the level of overflow in top chamber 58′ reaches the level of the top openings 76′ of the wetted wall separation tubes 72′, it enters and flows down the hollow tubes 72′, aided by gravity. As the liquid 74′ proceeds down tubes 72′, a lower pressure is applied at the top of the tubes 72′ by applying a vacuum 78′ along path 80′ leading from the top chamber 58′ of vessel 54′. Optionally, instead of applying a vacuum, the lower pressure is applied in some embodiments by forcing an air flow from the bottom openings 82′ of tubes 72′, disposed within bottom chamber 62′ of vessel 54′, toward the top openings 76′, such as by a blower (not shown). Application of lowered pressure aids in the evaporation of the water miscible solvent from the slurry, and the organic solvent is condensed and collected via path 80′ and condensed via condenser 84′, and the condensed water miscible solvent 26 is stored in storage tank 86′. In some embodiments, this organic solvent is recycled back to the one or more sources such as sources 24n depicted in FIG. 9A, for reuse in a subsequent separation.

Within the vessel 54′, the tubes 72′ have openings 76′ that project into top chamber 58′ and openings 82′ that project into bottom chamber 62′. Between top chamber 58′ and bottom chamber 62′ of vessel 54′, an optional jacketed area 66′ surrounds tubes 72; the optional jacketed area 66′ has inlet 68′ and outlet 70′. In some embodiments, a heated fluid is pumped into inlet 68′, for example, by a liquid pump or heated gas pump (not shown) and exits via outlet 70′. As evaporation occurs within tubes 72′, loss of heat of evaporation is mitigated by adding heat to the jacketed area 66′.

In some embodiments, the wetted wall separation tubes achieve evaporation of the water-miscible solvent from the salt slurry while maintaining substantial separation of the precipitated salt, that is, preventing subsequent redissolution of the salt in the water as the water miscible solvent is evaporated. This is achieved by a contour feature of the tubes as well as the inner diameter thereof. In embodiments, the wetted wall separator tubes of the invention are characterized primarily by inner diameter defining the inner wall, and height of the tube in combination with the contour feature defining at least a portion of the inner wall.

The rate of evaporation of the water miscible solvent from the salt slurry is determined by both the wetted wall separation tube itself and by additional factors. The tube properties affecting evaporation include the height of the tube, the contour dimensions of the inner wall of the tubes and the portion of the inner wall having the contour feature thereon, and the heat transfer properties of the tube—that is, tube material properties, thickness of the tube, and presence of heat transfer features present on the outer surface of the tube. Additional factors include the heat of vaporization of the water miscible solvent, external temperature control, such as by a jacketed area 66′ shown in FIG. 9C, and the amount of pressure differential within the hollow separator tube between the top and bottom of the tube length. The height of the tubes useful in the evaporation is not particularly limited, and will be selected based on the amount of water miscible solvent entrained in the slurry and the heat of evaporation of the water miscible solvent. In some embodiments, the height of the wetted wall separator tubes useful in conjunction with the separation of water miscible solvent from a slurry of sodium chloride in water, using ethylamine as the water miscible solvent, is about 50 cm to 5 meters, or about 100 cm to 3 meters. In embodiments, the portion of the total length of the tube that includes the helical threaded features present on the inner wall thereof is between about 50% and 100% of the total inner wall surface area, or about 90% to 99.9% of the total wall surface area, or about 95% to 99.5% of the total inner wall surface area.

Separator Apparatus

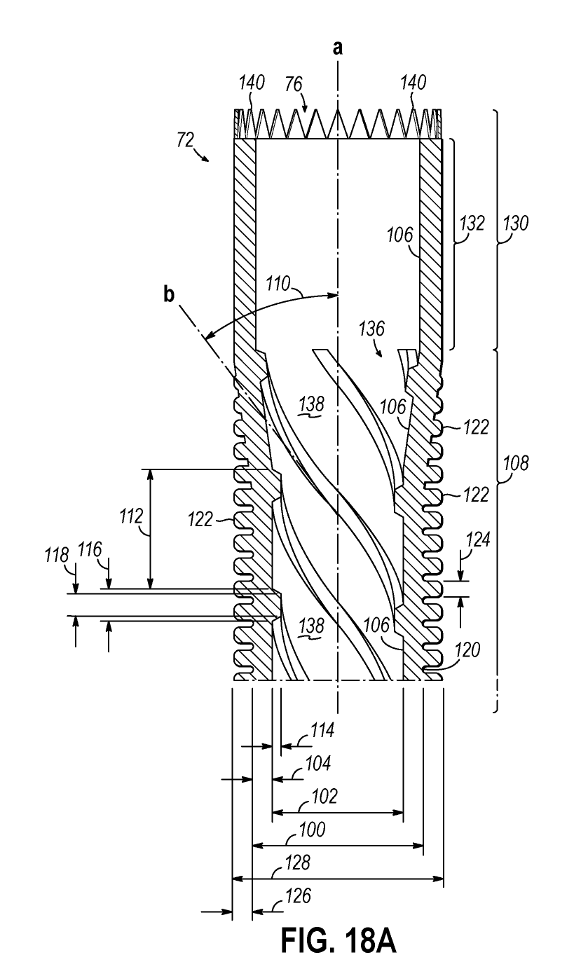

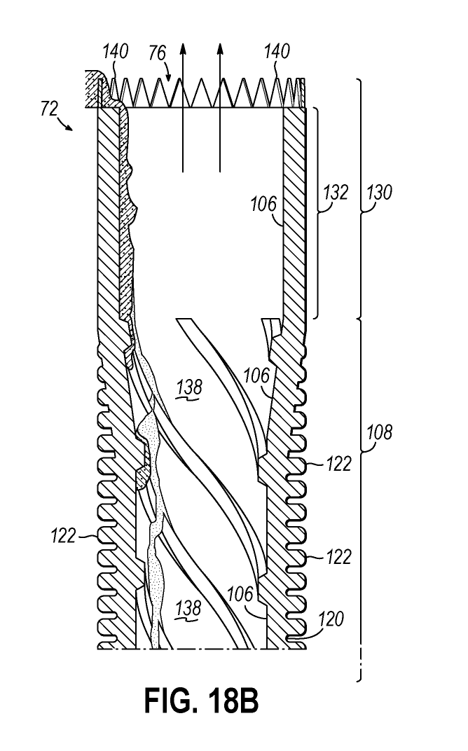

A detail of the apparatus used in the solvent separation process (liquid degassing) is shown in FIGS. 18A and 18B. Liquid degassing is a process in which the liquid containing a low boiling point organic solvent or a dissolved gas is pumped to the top of the degassing system vessel, and the liquid, which may contain a precipitated salt, flows down vertical, high surface area tubes, by gravity. Both the overflow and the underflow liquids (from FIG. 9A) are pumped to the top of such liquid degassing vessels, as shown in FIGS. 9B and 9C. As the liquid flows down the high surface area tubes by gravity, a lower pressure is applied at the top of the tubes using a vacuum pump or even a gas blower. This allows the lower boiling point organic solvent to evaporate out of the water and salt solution, and this organic solvent is condensed and collected in storage tanks. This organic solvent may be recycled back to the in-line mixer 16 (FIG. 9A) to be re-used.

FIGS. 18A and 18B show a schematic detail of the interior and exterior of the high surface area tubes 48, which provide a high surface area between the liquid and gas phases, allowing all the organic solvent to be recovered by evaporation. To assist in this evaporation, some ambient air may be introduced at the bottom of the tubes into the liquid degassing vessels and this air is vented after the condenser, from the organic liquid storage tanks

The evaporating of solvent contemplates, in some embodiments, the use of a wetted wall separation tube. The tube is in the shape of a hollow cylinder or a pipe, or it can be a hollow frustoconical shape, or a hollow cylinder or a pipe having a frustoconical portion. The tube includes an inner wall and an outer wall wherein a contour, such as a helical threaded feature, defines at least a portion of the inner wall. In some embodiments the helical threads are of substantially the same dimensions throughout the portion of the inner wall where they are located; in other embodiments, helical threads of different dimensions occupy different continuous or discontinuous areas of the tube. In some embodiments, a series of fins defines at least a portion of the outer wall. In some embodiments, the tubes also include one or more weirs proximal to, or spanning, the opening of one end of the tube. In some embodiments, the tubes 48 also include a smooth inner wall portion proximal to one end of the tube.

Further detail regarding the inner and outer wall features of the separation tubes are shown in FIGS. 18A and 18B. FIGS. 18A and 18B are a schematic representation of area of at least one of the tubes 72 shown in FIG. 9B, depicting a section of the length of the tube as indicated, further bisecting the tube in a plane extending lengthwise through the center thereof. The features of FIGS. 18A and 18B are further defined by dimensions represented by lines a, b, and arrow lines 100, 102, 104, 112, 114, 116, 118, 124, 126, and 128 of FIG. 18A. Arrows 100, 102, 104, 112, 114, 116, 118, 124, 126, and 128 of FIG. 18A are used where appropriate to describe the various features and dimensions of the indicated section of wetted wall separation tubes. It will be appreciated that the detailed schematic diagram of FIGS. 18A and 18B are only one of many potential embodiments of the wetted wall separator tubes of the invention. Additional embodiments will be reached by optimization depending on the particular application to be addressed.

Referring to FIGS. 18A and 18B, one embodiment of a wetted wall separation tube 72 is defined by effective outer diameter 100 and effective inner diameter 102 which together define the effective thickness 104 of tube section. For purposes of separating an inorganic salt from water, the tube inner diameter 102 is between about 3 cm and 1.75 cm, or between about 2.5 cm and 1.9 cm. However, for other types of separations, the inner diameter 102 will be optimized to provide the required balance of flow differences between the solid phase and the liquid phase to maintain the solid within the helical grooves and allow the liquid to flow in substantially vertical fashion over the helix ribs when the selected slurry is added to the top opening 76 of wetted wall separation tubes 72. The inner diameter 102 of tube section defines inner wall 106 of tube section Inner wall 106 includes a helical threaded section 108 defined by helix angle 110 which is defined in turn by lines a, b; helix pitch 112; helix rib height 114; helix base rib width 116, and helix top rib width 118. Helix “land” width is defined as the helix pitch 112 minus helix base rib width 116. Helical threaded section 108 of FIGS. 18A and 18B is further defined for purposes of separating an inorganic salt from water as follows. In embodiments, the helix angle 110 is about 25° to 60° or about 30° to 50°, about 35° to 50°, or even about 38° to 48°. In embodiments, the helix pitch 112 is about 0.25 mm to 2 mm, or about 0.5 mm to 1.75 mm, or about 0.75 mm to 1.50 mm, or about 0.85 mm to 1.27 mm. In embodiments, the helix rib height 114 is about 25 μm to 2 mm, or about 100 μm to 1 mm, or about 200 μm to 500 μm. In some embodiments the helix rib height 114 is about 254 μm. In embodiments, the helix base rib width 116 is about 25 μm to 2 mm, or about 100 μm to 1 mm, or about 200 μm to 500 μm. In embodiments, the helix top rib width 118 is about 0 μm (defining a pointed tip with no “land”) to 2 mm. In some embodiments, helix rib top width 118 is the same or less than helix rib base width 116. In some embodiments, the helix rib profile is triangular or quadrilateral. The helix rib profile shape is triangular in embodiments where helix top rib width 118 is 0; a square or rectangular shape where helix top rib width 118 is the same as the helix base rib width 116; or a trapezoidal shape where helix rib top width 118 is greater than 0 but less than the helix rib base width 116. While helix rib shapes wherein helix rib top width 118 is greater than helix base rib width 116 are within the scope of the invention, in some embodiments, such features are difficult to impart to the interior of a tube such as tubes 72. Further, the helix rib top can be tilted with respect to the approximate plane of the surrounding wall; that is, angled with respect to the vertical plane. Providing a tilted helix rib top will, in some embodiments, increase or decrease the degree of turbulence generated in the flow of the liquid as it proceeds vertically within the tube.

Additionally, while the shape of the helix ribs are not particularly limited and irregular or rounded shapes for example are within the scope of the invention, in embodiments it is advantageous to provide a regular feature in order to maintain laminar flow within the helix land area. Further, in embodiments it is advantageous to provide an angular feature such as a trapezoidal or rectangular feature in order to incur some capillary pressure to maintain the laminar flow within the boundaries of the helix land area. However, it will be recognized by those of skill that machining techniques, such as those employed to machine a helical feature into the interior of a hollow metal tube, necessarily impart some degree of rounding to a feature where angles are intended. As such, in various embodiments the angularity of the features is subject to the method employed to form the helical threaded features that define the inner wall of 10 the wetted wall separation tubes of the invention.

Referring again to FIGS. 18A and 18B, as noted above, the effective outer diameter 100 and effective inner diameter 102 together define the effective thickness 104 of tube section. Effective thickness of the tube is, in various embodiments, about 0.1 mm to 10 mm, or about 0.25 mm to 3 mm, or 0.5 mm to 1 mm where the tube is fabricated from a metal, such as a stainless steel. However, the effective thickness of the tube is selected based on the material from which the tube is fabricated as well as heat transfer properties of the material and other features that will be described in more detail below, and also for convenience. It will be appreciated that an advantage of the wetted wall separator tubes of the invention is that the tubes do not include and are not contacted with moving machine parts, and are not subjected to harsh conditions or large amounts of abrasion, stress, or shear. Therefore, it is not necessary to provide very thick effective wall thickness of the tubes, nor is it necessary to fabricate the tubes from metal, in order to achieve the goal of evaporating the water miscible solvent from the slurry.

Referring again to FIGS. 18A and 18B, the outer diameter 100 of tube section defines outer wall 120 of tube section. Outer wall 120 may include a series of fins 122 protruding from outer wall 120, wherein the fins are defined by fin thickness 124 and fin height 126. The fins are employed in embodiments for temperature control, for example by adding heat via the jacketed area 66 as shown in FIG. 9B, to increase the rate of heat transfer. In some embodiments (not shown), there is land between the fins; in other embodiments the fins do not have land area between them. The purpose of the fins inside the pipe is to break up the liquid flow into smaller streams and create turbulence, which increases the contact surface area between the gas and liquid phases. The purpose of the corrugated fins outside the tube is to increase the surface area between the fluid outside the tubes and the liquid flowing down inside the tubes, so we can heat/cool the liquid effectively.

The shape of the fins are not particularly limited and in various embodiments rounded, angular, rectilinear or irregularly shaped fins are useful. The dimensions of the fins are not particularly limited and are determined by employing conventional heat transfer calculations optimized for the targeted evaporation process. In some embodiments, the fins have fin thickness, or width, 124 of about 0.1 mm to 10 mm, or about 0.5 mm to 5 mm, or about 0.75 mm to 2 mm. In some embodiments, the fins have fin height 126 roughly the same as the fin thickness. The dimension of the fins is incorporated into the total width 128 of the tubes. In some embodiments, instead of fins encircling the tubes, discrete projections protrude from the outer walls in selected locations. In some embodiments, the fins or projections are present over a portion of the outer wall wetted wall separator tubes; in other embodiments the fins or projections are present over the entirety thereof. However, the presence of any fins or projections is optional and in some embodiments fins or projections are unnecessary to achieve effective evaporation of the water miscible solvent.

An additional optional feature of the wetted wall separator tubes of the invention includes an entry section proximal to the top openings of the tubes that facilitates and establishes a suitable flow of the slurry entering the tube. The entry section 130 includes the top opening 76 and a first portion 132 of the inner wall 134 of the tube. A suitable flow is created when slurry enters the tube in a volume and flow pattern enter the helical threaded portion 136 of the tube in a manner wherein the solids tend to enter the helical threaded area beneath the entry section and flow in laminar fashion within the land area 138 between the helix ribs, and the bulk of the liquid phase tends to flow substantially vertically within the tube, further wherein the vertical flow is turbulent by virtue of passing over the helix rib features. The design of the entry section will vary depending on the nature of the slurry as well as the design of the helical thread situated further along the tube as the slurry proceeds vertically. For separation of a slurry of sodium chloride, we have found that the entry section optionally includes weirs 140 proximal to the top opening, and a smooth inner wall 134 extending from the top opening 76 to the onset of the helical threaded portion 136 of the tube. The weirs are designed to provide a substantially laminar flow of slurry at a suitable volume for flowing across and into the helical threaded area of the inner wall of the tube. In some embodiments, the weirs are rounded features, such as O-ring shaped features, placed proximal to and above the top opening, that facilitate slurry flow into the tube such that the flow proceeds in contact with the inner wall thereof. In other embodiments, the weirs are a series of walls, slotted features, or perforated openings disposed above and extended across the top opening, and shaped to provide flow of the slurry into the tube such that the flow proceeds in contact with the inner wall thereof. In some such embodiments, the weirs also regulate the rate of flow into the tube. The weirs are formed from the same or a different material or blend of materials than the tube itself, without limitation and for ease of manufacture, provision of a selected surface energy, or both.

In embodiments, the weirs are followed, in a portion of the tube proximal to and below the top opening, by a smooth inner wall section. The smooth inner wall section is characterized by a lack of a helical threaded feature or any other feature that causes disruption of the slurry in establishing a laminar downward flow within the tube. In embodiments, the smooth inner wall section extends vertically from the top opening of the tube to about 0.5 mm to 10 mm from the top opening of the tube, or about 1 mm to 5 mm from the top opening of the tube. Proximal to the smooth inner wall section in the vertical downward direction, the helical threaded portion of the inner wall begins. In some embodiments the smooth inner wall section has a substantially cylindrical shape; in other embodiments it has a frustoconical shape; that is, the smooth inner wall of the tube is frustoconical leading to the helical threaded inner wall portion. The frustoconical shape is not necessarily mirrored on the outer wall of the tube, though in embodiments it is. In general, where the smooth inner wall section has a frustoconical shape, the conical angle is about 1° to 10° from the vertical.

It will be understood that the fins 122 on the outer wall of the wetted wall separator tubes, as shown in FIGS. 18A and 18B, weirs, and a smooth inner wall section are optional features, and that the only feature necessary to the wetted wall separator tubes of the invention are the basic hollow cylinder or frustoconical shape having an inner wall and an outer wall wherein a helical threaded feature defines at least a portion of the inner wall. In embodiments, the helical threaded feature extends over a significant portion of the inner wall, and in other embodiments the helical threaded feature extends over substantially the entirety of the inner wall. In still other embodiments, the helical threaded feature extends over substantially the entirety of the inner wall except for the smooth inner wall portion of the tube as described above.

In the evaporation systems of the invention, such as the system 50 shown in FIG. 9B, there is at least one wetted wall separation tube 72. The number of tubes employed, in an array of tubes contained within an evaporation apparatus, is not limited and is dictated by the rate of delivery of slurry into the apparatus. In some embodiments, an evaporation apparatus of the invention includes between 2 and 2000 wetted wall separation tubes, disposed substantially vertically and parallel to each other and having the top openings 76 substantially in the same plane. In some embodiments where two or more tubes are present in an evaporation apparatus, the tubes are placed far enough apart from one another to provide for efficient heat transfer with the surrounding environment; where a jacketed area surrounds the tubes this spacing must account for efficient flow of the heat transfer fluid around and between the tubes. It will be appreciated that the number of tubes present in a particular evaporation apparatus of the invention will be adjusted based on the selected flow rate of slurry delivered by the precipitation apparatus such as the apparatus of FIG. 9A. In some embodiments, more than one evaporation apparatus 54 is connected to path 52, or chamber 58 is split into two or more chambers, in order to address total flow of slurry from flow path 52 into the tubes 72. Such compartmentalized control is useful because tubes 72 have a range of flow operability, that is, a minimum and a maximum flow capacity wherein turbulent wetted wall flow is achieved. Higher flow rates from flow path 52 require the use of more tubes, once the maximum flow capacity of one tube or one group of tubes is reached.

The wetted wall separation tubes of the invention are not particularly limited as to the materials used to form them. Layered or laminated materials, blends of materials, and the like are useful in various embodiments to form the wetted wall separation tubes of the invention. Materials that form the inner wall and thus the helical threaded features are selected for machining or molding capability, imperviousness to the materials to be contacted with the inner wall, durability to abrasion from the particulates in the slurries contacted with the inner wall, heat transfer properties, and surface energy of the material selected relative to the surface tension of the slurry to be contacted with the inner wall. In various embodiments, the wetted wall separator tubes of the invention are formed from metal, thermoplastic, thermoset, ceramic or glass materials as determined by the particular use and temperatures encountered. Metal materials that are useful are not particularly limited but include, in embodiments, single metals such as aluminum or titanium, alloys such as stainless steel or chrome, multilayered metal composites, and the like. It is important to select a metal for the inner wall of the tubes that is impervious to water, salt water, or the selected water miscible solvent. In some embodiments, metals have the additional advantage of providing excellent heat transfer, and so are the material of choice. In some embodiments, stainless steel is a suitable material for use in conjunction with the separation of sodium chloride from water. In some embodiments, it is advantageous to employ thermoplastic materials as part of, or as the entire composition of the tubes due to ease of machining or to minimize cost, or both. Further, in embodiments thermoplastics may be molded around a helically-shaped template and the helical threaded features imparted to the molded tubes are, in some embodiments, more defect-free than their metal counterparts. However, a thermoplastic selected to compose the inner wall of the tube must be substantially impervious to any effects of swelling or dissolution by water, salt water, or the selected water miscible solvent and substantially durable to the abrasion provided by movement of slurry particles within the tubes. Examples of suitable thermoplastics for some applications include polyimides, polyesters, polycarbonate, polyurethanes, polyvinylchloride, fluoropolymers, chlorofluoropolymers, polymethylmethacrylate, polyolefins, copolymers or blends thereof, and the like. The thermoplastics further include, in some embodiments, fillers or other additives that modify the material properties in a way that is advantageous to the overall properties of the tube, such as by increasing abrasion resistance, increasing heat resistance, raising the modulus, or the like. Thermosets are typically crosslinked thermoplastics wherein the crosslinking provides additional dimensional stability during e.g. temperature changes or any tendency of the polymer to dissolve or degrade in the presence of water, salt water, or the selected water miscible solvent. Radiation crosslinked polyolefins, for example, are suitable for some applications to form the inner wall or the entirety of a wetted wall separation tube of the invention. Ceramic or glass materials are also useful materials from which to form the wetted wall separation tubes of the invention and are easily machined to high precision in some embodiments.

The wetted wall separation tubes are particularly well suited for providing a means for evaporating the water miscible organic solvent from the salt slurry formed using the methods of the invention. It is an advantage of the wetted wall separation tubes that no moving parts reside within the tubes; and that the tubes are of simple design; and that the tubes contain no features that tend to collect and/or aggregate the slurry particles. The evaporation of the water miscible solvent is highly efficient using the wetted wall separation tubes of the invention, and the solid slurries particles are able to proceed in unfettered fashion downward through the tube. The wetted wall separation tubes provide a high surface area between the liquid and gas phases, allowing substantially all of the water miscible solvent to be recovered by evaporation and resulting in an overall efficient and rapid evaporation process. Because the salt crystals formed during the fractional addition of the water miscible solvent are small, they can be carried down the tubes along with some amount of liquid, in some embodiments in a substantially laminar flow that follows the helical threaded pathway.

Referring once again to FIG. 9B, after evaporation from the wetted wall separation tubes 72, a concentrated salt slurry 150 exits tubes 72 at bottom openings 82 thereof. The precipitated salt and water, now substantially free of water miscible solvent, flow into bottom chamber 62 and exit outlet 64 as a concentrated salt slurry. In some embodiments, the salt crystals have been subjected to substantially laminar flow and do not tend to redissolve in the water as the water miscible solvent is removed from the turbulent flow. Thus, the crystals are easily isolated from the concentrated salt slurry exiting tubes 72 at bottom openings 82. The concentrated salt slurry is deposited into a collection apparatus 152. Collection apparatus 152 as shown is the same or similar to cylinder formers developed for papermaking applications, as will be appreciated by those of skill. Cylinder former 152 includes a horizontally situated cylinder 154 with a wire, fabric, or plastic cloth or scrim surface that rotates in a vat 156 containing the concentrated salt slurry 150 delivered from exit outlet 64. Water associated with the slurry 150 is drained through the cylinder 154 and a layer of precipitated salt is deposited on the wire or cloth, and exits collection apparatus 152 via pathway 158. The drainage rate, in some designs, is determined by the slurry concentration and treated water level inside the cylinder such that a pressure differential is formed. As the cylinder 154 turns and water is drained from the slurry, the precipitate layer that is deposited on the cylinder is peeled or scraped off of the wire or cloth, such as with a scraper blade 160 or some other apparatus, and continuously transferred, such as via a belt 162 or other apparatus, to receptacle 164. In some embodiments, during transport of the deposited layer of salt 166 to the receptacle 164, the salt is dried, such as by applying a hot air knife (not shown) across the belt 162 or by heating belt 162 directly, or by some other conventional means of drying salt crystals.

In some embodiments, water exiting collection apparatus 152 via pathway 158 may be sent to a subsequent treatment apparatus, such as ultrafiltration or nanofiltration, in order to remove the remaining salt or another impurity.

In some embodiments, the tubes are surrounded by a source of heat 66 to aid in the evaporation. In some embodiments, the water miscible organic solvent is collected by providing a condenser or other means of trapping the evaporated solvent that exits the top of the wetted wall separator tubes due to the flow of gas upward through the tubes. The evaporated solvent is significantly free, or substantially free, of evaporated water, which enables the isolation of sufficiently pure solvent. The ability to collect the water miscible solvent enables the solvent to be incorporated in a closed system of solvent recycling within the overall precipitation and evaporation process.

It will be appreciated that depending on the type of gas-liquid-solid separation to be carried out, the ratio of liquid to solid in the slurry, and the flow rate selected for the slurry through the tube, the inner diameter of the tube, the helix angle of the helical thread, and the dimensions of the helical features will necessarily be different in order to effect the most efficient separation.

The liquid degassing vessel is one method to achieve a high surface area between the gas and liquid phases. Other methods that could be used is a packed tower, with packing to increase the contact surface area between the gas and liquid phases, or even a spray tower in which the liquid is sprayed in the form of small droplets into the gas phase, which is maintained at a lower pressure. The low boiling point solvent would then transfer from the liquid to the gas phase.

Degassing of the organic solvent means that the organic solvent should have a low boiling point and preferably a low heat of vaporization. However, the energy of vaporization needs to be supplied in order to convert the organic to the vapor state and remove it from the liquid water phase. In order to achieve a high removal efficiency for the organic, the boiling point difference between the organic and water should be as large as possible. Hence, some of the possible organics listed in Table 3 have a low boiling point when compared to water.

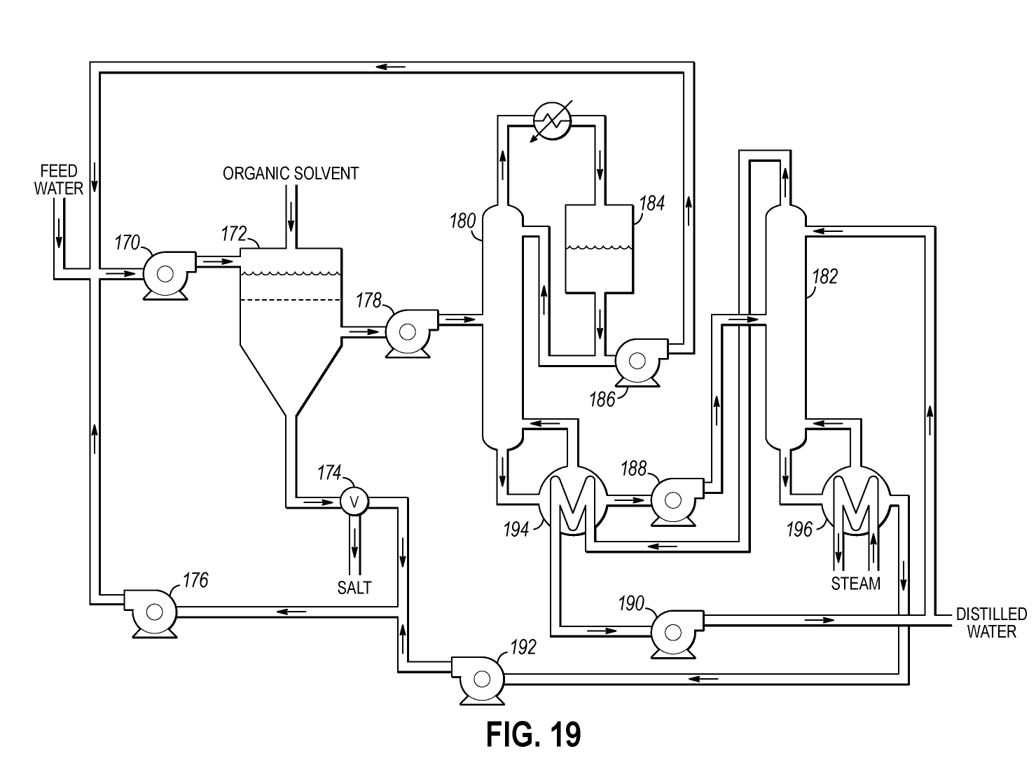

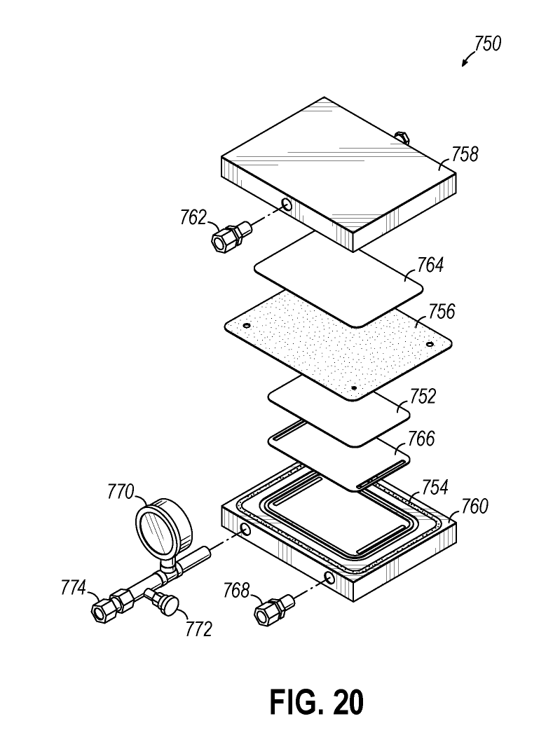

If the boiling point of the organic solvent and water are not very different, a multi-effect distillation column can be used to separate the organic from the water and achieve a high degree of separation for the solvent. As is known to those of ordinary skill in the art, multi-effect distillation is a distillation process that includes multiple stages. In each stage, the feed liquid (e.g., water) is heated (such as by steam) in tubes. Some of the liquid evaporates, and this steam flows into the tubes of the next stage, heating and evaporating more liquid. Each stage essentially reuses the energy from the previous stage. FIG. 19 shows an example of a multi-effect distillation column in which organic solvent is separated using two distillation columns operating at two different pressures. In this embodiment, one column operates at a higher pressure than the other column, and in the higher pressure column, the temperature of the condenser is higher than the temperature of the reboiler, which allows the heat evolved by the condensation of the vapors to be used to reboil the liquid in the reboiler.

More specifically, and referring to FIG. 19, the feed water, containing salts (monovalent, divalent, etc.), enter into feed pump 170 and then flows into settler vessel 172. The feed water may be any water prior to any contact with solvent—and as can be seen from the figure, and as will be described in greater detail below, the feed water will mix (in the illustrated embodiment) with recovered streams containing solvent. Additional solvent is added to the vessel 172 also, to make up any loss of organic solvent. Such loss occurs, for example because any liquid removed from the settler vessel will likely include some amount of solvent, and so to maintain the amount of solvent in the vessel, the solvent needs to be replenished. In the settler vessel 172, some of the divalent and monovalent salts are precipitated (due to the presence of solvent), and the resulting slurry of water and precipitated salts is removed through valve 174. Alternatively or additionally, some of this precipitated salt and water is recycled back to the starting point (i.e., feed point) using the recycle pump 176, where it is again directed into the settler vessel 172 via feed pump 170. The salt crystals that are present in this recycled slurry (of water and precipitated salt) assist in nucleating further salts (divalent, monovalent, etc.) from further incoming feed water, which promotes greater growth of salt crystals (upon solvent-induced precipitation from the feed water), which in turn promotes faster settling of precipitated salt in the settler, due to the increased crystal size.

The more clear portion of water from the settler, i.e., that portion having a lower concentration of salts (divalent, monovalent, etc.), will be located nearer to the top of the body of liquid in the tank 172, since the salt crystals will generally sink toward the bottom of the tank 172 (as described above). Thus, this more clear portion of water may be pumped by pump 178 into a first distillation column 180 (for removal of solvent), which may be set to operate at a lower pressure than a second distillation column 182. The organic solvent is removed as a pure compound or as a azeotropic composition with water as the top product, which is condensed, and collected in overhead product drum 184. A portion of the recovered solvent may then be returned back to the top of the first distillation column 180 as reflux, and the remaining portion may be recycled back to the settler tank 172 using pump 186. In this manner the organic solvent is recovered and recycled back to the settler 172 to precipitate more salt from the feed water.

The bottom product, (i.e., the portion that exits the bottom of the first distillation column 180) containing salts and water, may be partially reboiled back as water vapor (via the use of first heat exchanger 194) and returned back to the bottom of this distillation column. The remaining portion of this bottom product may be withdrawn by pump 168 and fed into the second distillation column 182, which operates at a higher pressure than the first distillation column 180. The reason for operating the second distillation column 182 at a higher pressure than the first distillation column 180 is due to the fact that at a higher pressure, the boiling point (condensing temperature) of the pure water, produced in the top product of distillation column 182, will be higher than the boiling point of the bottom product of the first distillation column 180, and thereby the heat of condensation of water vapor exiting the top of second distillation column 182 can be used to partially vaporize the bottom product of first distillation column 180 (as shown in FIG. 19). This allows heat integration of the two distillation columns to minimize the net energy consumption within this process. The second distillation column 182 is operated at a pressure such that this heat transfer can occur economically with a reasonable temperature driving force and heat exchanger area.

The top product of second distillation column 182 is pure water, with no salt, and this water is pumped by pump 190 as the distilled water product. The bottom product of distillation column 182 includes mainly salt water. A portion of this bottom product may be partially reboiled back as water vapor (via the use of second heat exchanger 196) and returned back to the bottom of the second distillation column 182. The remaining portion of this salt water is pumped by pump 192 back to the settler to allow more salt to be precipitated.

By using the two distillation columns with heat integration, achieved by operating the second column 182 at a higher pressure than distillation column 180, the organic solvent is recovered and recycled back and salt is continuously precipitated from the feed water.

The salt slurry produced from the bottom of the settler can be further filtered, (filter not shown in FIG. 19), and the salt water, once separated from the wet salt, can also be recycled back to the settler.

While the various aspects of the present invention have been disclosed by reference to the details of various embodiments of the invention, it is to be understood that the disclosure is intended as an illustrative rather than in a limiting sense, as it is contemplated that modifications will readily occur to those skilled in the art, within the spirit of the invention and the scope of the appended claims.

What is claimed is:

1. An electrodialysis apparatus, comprising:
an anode;
a cathode; and
a plurality of chambers between said anode and said cathode, each chamber of the plurality of chambers being at least partially defined by a membrane, such that the apparatus includes a plurality of membranes;
wherein at least one membrane of said plurality of membranes allows passage therethrough of monovalent ions, but substantially prevents the passage therethrough of multivalent ions.

2. The electrodialysis apparatus of claim 1, wherein at least two membranes of said plurality of membranes allow passage therethrough of monovalent ions, but substantially prevent the passage therethrough of multivalent ions.

3. The electrodialysis apparatus of claim 2, wherein the at least two membranes that allow passage therethrough of monovalent ions but substantially prevent the passage therethrough of multivalent ions are nanofilter membranes.

4. The electrodialysis apparatus of claim 3, wherein the nanofilter membranes have a nominal pore size of 1 nm.

5. The electrodialysis apparatus of claim 1, wherein said plurality of chambers includes at least first, second, third, fourth, and fifth chambers, with said first chamber being proximal to said cathode and said fifth chamber being proximal to said anode,
said second chamber being adjacent said first chamber on the opposite side of said first chamber from said cathode,
said fourth chamber being adjacent said fifth chamber on the opposite side of said fifth chamber from said anode, and
said third chamber being positioned between said second chamber and said fourth chamber;
wherein the membrane separating said first chamber from said second chamber allows passage therethrough of monovalent ions, but substantially prevents the passage therethrough of multivalent ions; and
wherein the membrane separating said fourth chamber from said fifth chamber allows passage therethrough of monovalent ions, but substantially prevents the passage therethrough of multivalent ions.

6. The electrodialysis apparatus of claim 5, further comprising an inlet for the passage of a liquid including monovalent and multivalent ionic species into at least said third chamber.

7. The electrodialysis apparatus of claim 5, further comprising at least a first fluid passageway outlet in fluid communication with said first chamber and said fifth chamber for the passage of fluid including monovalent ions, and a second fluid passageway outlet in fluid communication with said second chamber and said fourth chamber for the passage of fluid containing multivalent ions.

8. The electrodialysis apparatus of claim 7, wherein the first fluid passageway outlet is adapted to restrict the amount of fluid that passes therethrough in order to increase the concentration of monovalent ions present in fluid from the first chamber and the fifth chamber that exits the first fluid passageway outlet.

9. A method of separating monovalent ions from multivalent ions in a liquid comprising subjecting a liquid containing monovalent ions and multivalent ions to an electric current in an electrodialysis cell including at least one membrane that allows passage therethrough of monovalent ions, but substantially prevents passage therethrough of multivalent ions.

10. The method of claim 9, wherein the electrodialysis cell comprises
an anode;
a cathode; and
a plurality of chambers between said anode and said cathode, each chamber of the plurality of chambers being at least partially defined by a membrane, such that the apparatus includes a plurality of membranes;
wherein at least first and second membranes of said plurality of membranes allow passage therethrough of monovalent ions, but substantially prevent the passage therethrough of multivalent ions; and
wherein the step of subjecting a liquid containing monovalent ions and multivalent ions to the electric current between said anode and said cathode causes:
positive monovalent ions to pass through the first membrane and positive multivalent ions to be blocked by the first membrane; and
negative monovalent ions to pass through the second membrane and negative multivalent ions to be blocked by the second membrane;
thereby separating monovalent ions from multivalent ions.

11. The method of claim 10, further comprising combining fluid containing positive monovalent ions with fluid containing negative monovalent ions to create a combined fluid containing positive and negative monovalent ions.

12. The method of claim 10, further comprising combining fluid containing positive multivalent ions with fluid containing negative multivalent ions to create a combined fluid containing positive and negative multivalent ions.

13. A system for desalination of a liquid, comprising:
an electrodialysis apparatus including at least one membrane that allows passage therethrough of monovalent ions, but substantially prevents passage therethrough of multivalent ions when a liquid containing monovalent ions and multivalent ions is subjected to an electric current in said electrodialysis cell;
a first precipitation chamber in fluid communication with said electrodialysis apparatus to receive fluid containing monovalent ions therefrom, and a second precipitation chamber in fluid communication with said electrodialysis apparatus to receive fluid containing multivalent ions therefrom, each of said first and second precipitation chambers containing therein a solvent to mix with the fluids to cause precipitation of salts in each of said fluids containing monovalent ions and containing multivalent ions;
a first filtration membrane in fluid communication with the first precipitation chamber, such that fluid substantially free of precipitate can be brought into contact with said first filtration membrane, wherein the first filtration membrane rejects and removes solvent from the fluid; and
a second filtration membrane in fluid communication with the second precipitation chamber, such that fluid substantially free of precipitate can be brought into contact with said second filtration membrane, wherein the second filtration membrane rejects and removes solvent from the fluid.

14. The system of claim 13, wherein the at least one membrane that allows passage therethrough of monovalent ions but substantially prevents the passage therethrough of multivalent ions is a nanofilter membrane.

15. The system of claim 14, wherein the nanofilter membrane has a nominal pore size of 1 nm.

16. The system of claim 13, further comprising:
a first fluid passageway fluidly connected to said first precipitation chamber for the removal of precipitated salt from said first precipitation chamber; and
a second fluid passageway fluidly connected to said second precipitation chamber for the removal of precipitated salt from said second precipitation chamber.

17. The system of claim 13, further comprising:
a first solvent passageway fluidly connected to the reject side of said first filtration membrane, the first solvent passageway adapted to return rejected and removed solvent from the first filtration membrane to said first precipitation tank; and
a second solvent passageway fluidly connected to the reject side of said second filtration membrane, the second solvent passageway adapted to return rejected and removed solvent from the second filtration membrane to said second precipitation tank.
